(19) United States
(12) Patent Application Publication
(10) Pub. No.: US 2026/0088192 A1
(43) Pub. Date: Mar. 26, 2026

(54) Integrated Battery and Method of Manufacturing the Same

(71) Applicant: LG Energy Solution, Ltd., Seoul (KR)

(72) Inventors: Dong Myung Kim, Daejeon (KR); Je Young Kim, Daejeon (KR); Dong Myung Shin, Daejeon (KR)

(73) Assignee: LG Energy Solution, Ltd., Seoul (KR)

(21) Appl. No.: 19/338,591

(22) Filed: Sep. 24, 2025

(30) Foreign Application Priority Data
Sep. 24, 2024 (KR) 10-2024-0128699
Sep. 22, 2025 (KR) 10-2025-0136613

(51) Int. Cl. G21H 1/06

(52) U.S. Cl. CPC G21H 1/06

(57) ABSTRACT

An integrated battery includes a substrate including a first material. The substrate includes a plurality of holes; a plurality of second material patterns each including a second material, wherein each second material pattern of the plurality of second material patterns is in a respective one of the plurality of holes, and wherein the second material has a polarity opposite to a polarity of the first material; a plurality of radiation sources configured to apply radiation to the substrate and the plurality of second material patterns; a plurality of third material patterns each including a third material; and a plurality of fourth material patterns each including a fourth material. Each third material pattern of the plurality of third material patterns is between a corresponding one of the plurality of radiation sources and a corresponding one of the plurality of fourth material patterns.

### CROSS-REFERENCE TO RELATED APPLICATIONS

This application claims priority under 35 U.S.C. § 119 to Korean Patent Application No. 10-2024-0128699, filed on Sep. 24, 2024, and to Korean Patent Application No. 10-2025-0136613, filed on Sep. 22, 2025, the entire contents of which are incorporated by reference herein.

### TECHNICAL FIELD

The present disclosure relates to an integrated battery and a method of manufacturing an integrated battery.

### BACKGROUND

An isotope battery is a type of battery that produces electricity using radiation emitted during the decay of a radioactive isotope. Generally, isotope batteries produce power using a radioactive isotope emitting beta rays and/or alpha rays and semiconductor materials. Isotope batteries operate by directly converting energy emitted during radioactive decay into electric energy.

Isotope batteries are capable of continuously producing energy during the half-life of the radioactive isotope and thus the lifespan thereof is very long. In addition, isotope batteries are capable of constantly supplying power regardless of an environment and thus can be used stably even in extreme environments.

### SUMMARY

### Technical Problem

There is a need for integrated, isotope batteries that have improved efficiency and for improved methods of making integrated isotope batteries. The present disclosure is directed to providing an integrated battery and a manufacturing method thereof.

### Technical Solution

Aspects of the present disclosure provide an integrated battery. The integrated battery includes a substrate comprising a first material, the substrate including a plurality of holes; a plurality of second material patterns each comprising a second material, wherein each second material pattern of the plurality of second material patterns is in a respective one of the plurality of holes and wherein the second material has a polarity opposite to a polarity of the first material; a plurality of radiation sources configured to apply radiation to the substrate and the plurality of second material patterns, wherein the radiation source comprises a radioactive isotope that emits beta rays; a plurality of third material patterns each comprising a third material; and a plurality of fourth material patterns each comprising a fourth material, wherein each third material pattern of the plurality of third material patterns is between a corresponding one of the plurality of radiation sources and a corresponding one of the plurality of fourth material patterns.

Each radiation source of the plurality of radiation sources may be between a corresponding one of the plurality of second material patterns and a corresponding one of the plurality of third material patterns.

A conductivity type of the first material may be the same as a conductivity type of the third material, and a conductivity type of the second material may be the same as a conductivity type of the fourth material.

A conductivity type of the second material may be the same as a conductivity type of the third material, and a conductivity type of the first material may be the same as a conductivity type of the fourth material.

A lower surface of each of the plurality of second material patterns, a lower surface of each of the plurality of radiation sources, a lower surface of each of the plurality of third material patterns, and a lower surface of each of the plurality of fourth material patterns may be coplanar with a lower surface of the substrate.

A lower surface of each of the plurality of second material patterns, a lower surface of each of the plurality of radiation sources, and a lower surface of each of the plurality of third material patterns may be coplanar with a lower surface of the substrate, and each of the plurality of third material patterns may have a cup shape.

A lower surface of each of the plurality of radiation sources and a lower surface of each of the plurality of second material patterns may be coplanar with a lower surface of the substrate, and each of the plurality of radiation sources may have a cup shape.

A lower surface of each of the plurality of second material patterns may be coplanar with a lower surface of the substrate, and each of the plurality of second material patterns may have a cup shape.

Aspects of the present disclosure are directed to an integrated battery. The integrated battery includes a substrate comprising a first material, the substrate including a plurality of holes; a plurality of second material patterns each comprising a second material, wherein each second material pattern of the plurality of second material patterns is in a respective one of the plurality of holes, and wherein the second material has a polarity opposite to a polarity of the first material; a plurality of radiation sources, wherein each radiation source of the plurality of radiation sources is in a respective one of the plurality of holes; a plurality of third material patterns each comprising a third material, wherein each third material pattern of the plurality of third material patterns is in a respective one of the plurality of holes, and wherein the third material pattern is spaced apart from the second material pattern in each respective one of the plurality of holes; and a plurality of fourth material patterns each comprising a fourth material, wherein each fourth material pattern of the plurality of fourth material patterns is in a respective one of the plurality of holes.

Each radiation source of the plurality of radiation sources may be between by a corresponding one of the plurality of second material patterns and a corresponding one of the plurality of the third material patterns.

Each third material pattern of the plurality of third material patterns may be between a corresponding one of the plurality of radiation sources and a corresponding one of the plurality of fourth material patterns.

Each fourth material pattern of the plurality of fourth material patterns may be at least partially surrounded by a corresponding one of the plurality of third material patterns.

Aspects of the present disclosure are directed to an integrated battery. The integrated battery includes a substrate comprising a first material, the substrate including a plurality of recesses extending into the substrate in a first direction from a first surface of the substrate; a second material layer on the substrate, the second material layer comprising a second material; a radiation source on the second material layer; a third material layer on the radiation source, the third material layer comprising a third material; and a fourth material layer on the third material layer, the fourth material layer comprising a fourth material.

The second material may have a conductivity type opposite a conductivity type of the first material, and the third material may have a conductivity type opposite to a conductivity type of the fourth material.

The conductivity type of the third material may be the same as a conductivity type of the first material, and a conductivity type of the fourth material may be the same as a conductivity type of the second material.

The conductivity type of the third material may be the same as a conductivity type of the second material, and a conductivity type of the fourth material may be the same as a conductivity type of the first material.

The substrate may include an electrical region comprising the plurality of recesses and a contact region free from the plurality of recesses, and the substrate, the second material layer, the radiation source, the third material layer, and the fourth material layer may form a step structure in the contact region.

In the contact region, the substrate may protrude from the electrical region into the contact region a greater distance than the second material layer.

In the contact region, the second material layer may protrude from the electrical region into the contact region a greater distance than the third material layer.

In the contact region, the third material layer may protrude from the electrical region into the contact region a greater distance than the fourth material layer.

A first cell including the substrate and the second material layer may be connected in series to a second cell including the third material layer and the fourth material layer.

A first cell including the substrate and the second material layer may be connected in parallel to a second cell including the third material layer and the fourth material layer.

The integrated battery may further include a first via electrically connected to the substrate, a second via electrically connected to the second material layer, a third via electrically connected to the third material layer, and a fourth via electrically connected to the fourth material layer.

The first via, the second via, the third via, and the fourth via may each include a passivation layer and a conductive layer at least partially surrounded by the passivation layer.

The first via may penetrate the second material layer, the third material layer, and the fourth material layer.

The second via may penetrate the third material layer and the fourth material layer.

The third via may penetrate the fourth material layer.

The substrate may include an electrical region with the plurality of recesses, a first contact region, and a second contact region, wherein the first contact region is spaced apart from the second contact region, with the electrical region between the first contact region and the second contact region, the first via and the third via may be on the first contact region, and the second via and the fourth via may be on the second contact region.

The integrated battery may further include a conductive line connected to the second via and the fourth via.

The substrate may include an electrical region comprising the plurality of recesses, a first contact region, and a second contact region, wherein the first contact region is spaced apart from the second contact region, with the electrical region between the first contact region and the second contact region, the second via and the third via may be on the first contact region, and the first via and the fourth via may be on the second contact region.

The integrated battery may further include a first conductive line connected to the second via and the third via, and a second conductive line connected to the first via and the fourth via.

### Advantageous Effects

An integrated battery according to aspects of the present disclosure includes a radiation source having a uniform thickness and a conformal shape to reduce the amount of the radiation source material used to manufacture the integrated battery and reduce manufacturing costs of the integrated battery. A pn junction and a depletion region are formed at opposite sides of the radiation source to increase energy efficiency of the integrated battery.

Effects achieved from aspects of the present disclosure are not limited to the above-described effects, and other effects that are not described herein will be clearly derived and understood by those of ordinary skill in the art to which the aspects of the present disclosure pertain from the following description. That is, unintended effects achieved when the aspects of the present disclosure are implemented may be derived by those of ordinary skill in the art from the aspects of the present disclosure.

### BRIEF DESCRIPTION OF DRAWINGS

Aspects of the present disclosure will be more clearly understood from the following detailed description in conjunction with the accompanying drawings in which:

FIG. 1 is a flowchart of a method of manufacturing an integrated battery according to an aspect.

FIG. 2 is a top plan view illustrating a step of a method of manufacturing an integrated battery according to an aspect.

FIG. 3 is a cross-sectional view taken along line 2I-2I′ of FIG. 2.

FIG. 4 is a top plan view illustrating a step of a method of manufacturing an integrated battery according to an aspect.

FIG. 5 is a cross-sectional view taken along line 4I-4I′ of FIG. 4.

FIG. 6 is a top plan view illustrating a step of a method of manufacturing an integrated battery according to an aspect.

FIG. 7 is a cross-sectional view taken along line 6I-6I′ of FIG. 6.

FIG. 8 is a top plan view illustrating a step of a method of manufacturing an integrated battery according to an aspect.

FIG. 9 is a cross-sectional view taken along line 8I-8I′ of FIG. 8.

FIG. 10 is a top plan view illustrating a step of a method of manufacturing an integrated battery according to an aspect.

FIG. 11 is a cross-sectional view taken along line 10I-10I′ of FIG. 10.

FIG. 12 is a top plan view illustrating a step of a method of manufacturing an integrated battery according to an aspect.

FIG. 13 is a cross-sectional view taken along line 12I-12I′ of FIG. 12.

FIG. 14 is a top plan view illustrating a step of a method of manufacturing an integrated battery according to an aspect.

FIG. 15 is a cross-sectional view taken along line 14I-14I′ of FIG. 14.

FIG. 16 is a cross-sectional view of an integrated battery according to an aspect.

FIG. 17 is a cross-sectional view of an integrated battery according to an aspect.

FIG. 18 is a cross-sectional view of an integrated battery according to an aspect.

FIG. 19 is a cross-sectional view of an integrated battery according to an aspect.

FIG. 20 is a cross-sectional view of an integrated battery according to an aspect.

FIG. 21 is a plan view of an integrated battery according to an aspect.

FIG. 22 is a cross-sectional view taken along line 21I-21I′ of FIG. 21.

FIG. 23 is a plan view of an integrated battery according to an aspect.

FIG. 24 is a cross-sectional view taken along line 23I-23I′ of FIG. 23.

FIG. 25 is a plan view of an integrated battery according to an aspect.

FIG. 26 is a cross-sectional view taken along line 25I-25I′ of FIG. 25.

FIG. 27 is a plan view of an integrated battery according to an aspect.

FIG. 28 is a cross-sectional view taken along line 27I-27I′ of FIG. 27.

FIG. 29 is a flowchart of a method of manufacturing an integrated battery according to an aspect.

FIG. 30 is a plan view illustrating a step of a method of manufacturing an integrated battery according to an aspect.

FIG. 31 is a cross-sectional view taken along line 30I-30I′ of FIG. 30.

FIG. 32 is a plan view illustrating a step of a method of manufacturing an integrated battery according to an aspect.

FIG. 33 is a cross-sectional view taken along line 32I-32I′ of FIG. 32.

FIG. 34 is a plan view illustrating a step of a method of manufacturing an integrated battery according to an aspect.

FIG. 35 is a cross-sectional view taken along line 34I-34I′ of FIG. 34.

FIG. 36 is a plan illustrating a step of a method of manufacturing an integrated battery according to an aspect.

FIG. 37 is a cross-sectional view taken along line 36I-36I′ of FIG. 36.

FIG. 38 is a cross-sectional view of an integrated battery according to an aspect.

FIG. 39 is a cross-sectional view of an integrated battery according to an aspect.

FIG. 40 is a plan view of an integrated battery according to an aspect.

FIG. 41 is a cross-sectional view taken along line 40I-40I′ of FIG. 40.

FIG. 42 is a cross-sectional view of an integrated battery according to an aspect.

FIG. 43 is a cross-sectional view of an integrated battery according to an aspect.

FIG. 44 is a cross-sectional view of an integrated battery according to an aspect.

FIG. 45 is a cross-sectional view of an integrated battery according to an aspect.

FIG. 46 is a flowchart of a method of manufacturing an integrated battery according to an aspect.

FIGS. 47 to 53 are cross-sectional views illustrating sequential steps of a method of manufacturing an integrated battery according to an aspect.

Like reference numerals and designations refer to the same elements in the figures. Additionally, various elements and areas of the figures are schematically depicted and are not necessarily drawn to scale. Accordingly, the aspects of the present disclosure are not limited to the relative sizes or spacing depicted in the accompanying drawings.

### DETAILED DESCRIPTION

Hereinafter, aspects of the present disclosure will be described in detail with reference to the accompanying drawings. Before describing aspects of the present disclosure, it should be understood that the terms or expressions used in the present specification and claims should not be construed as being limited to generally understood or common dictionary definitions, and should be understood according to meanings and concepts corresponding to the technology of the present disclosure on the basis of the principle that the inventor(s) can appropriately define the terms or expressions to optimally explain the technical features of the present disclosure.

Aspects set forth herein and configurations illustrated in the drawings are only some aspects of the present disclosure and do not reflect all the technical ideas of the present disclosure. Thus, it should be understood that various equivalents and modifications may have been made at the filing date of the present application.

Well-known configurations or functions related to aspects of the present disclosure are not described in detail when it is determined that they would obscure the subject matter of the present disclosure due to unnecessary detail.

Because aspects of the present disclosure are provided to more fully explain the technical features of the present disclosure to those of ordinary skill in the art, the shapes, sizes, etc. of components illustrated in the drawings may be exaggerated, omitted, or schematically illustrated for clarity. Therefore, it should be understood that the sizes or proportions of components illustrated in the drawings may not fully reflect the actual sizes or proportions thereof.

### First and Second Aspects

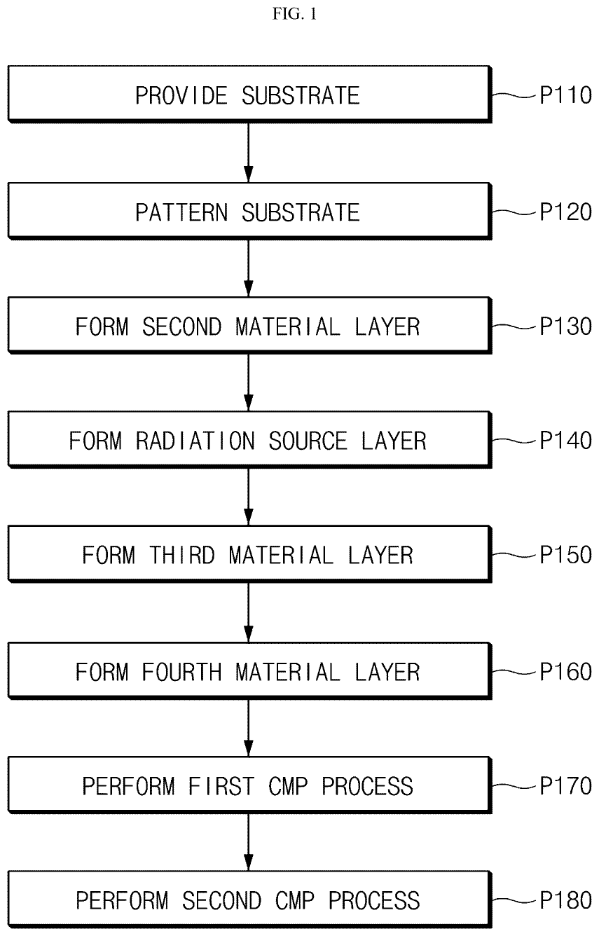

FIG. 1 is a flowchart of a method of manufacturing an integrated battery.

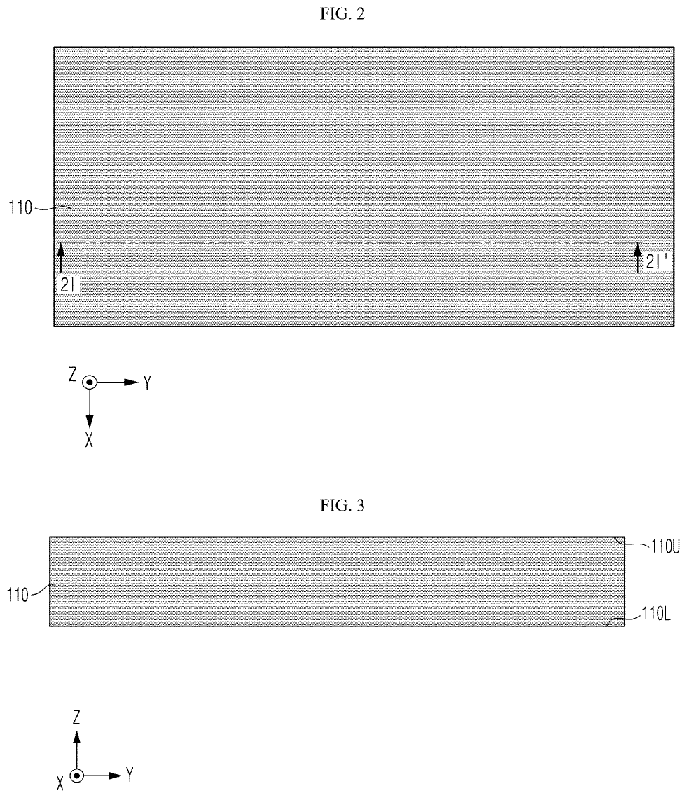

FIG. 2 is a top plan view illustrating a step of a method of manufacturing an integrated battery according to aspects.

FIG. 3 is a cross-sectional view taken along line 2I-2I′ of FIG. 2.

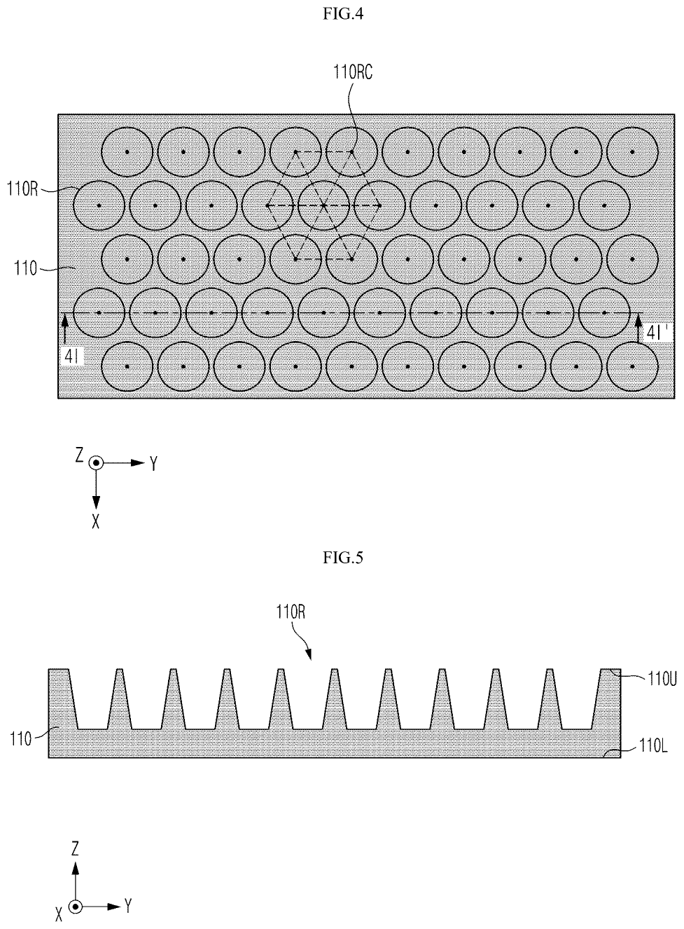

FIG. 4 is top a plan view illustrating a step of a method of manufacturing an integrated battery according to aspects.

FIG. 5 is a cross-sectional view taken along line 4I-4I′ of FIG. 4.

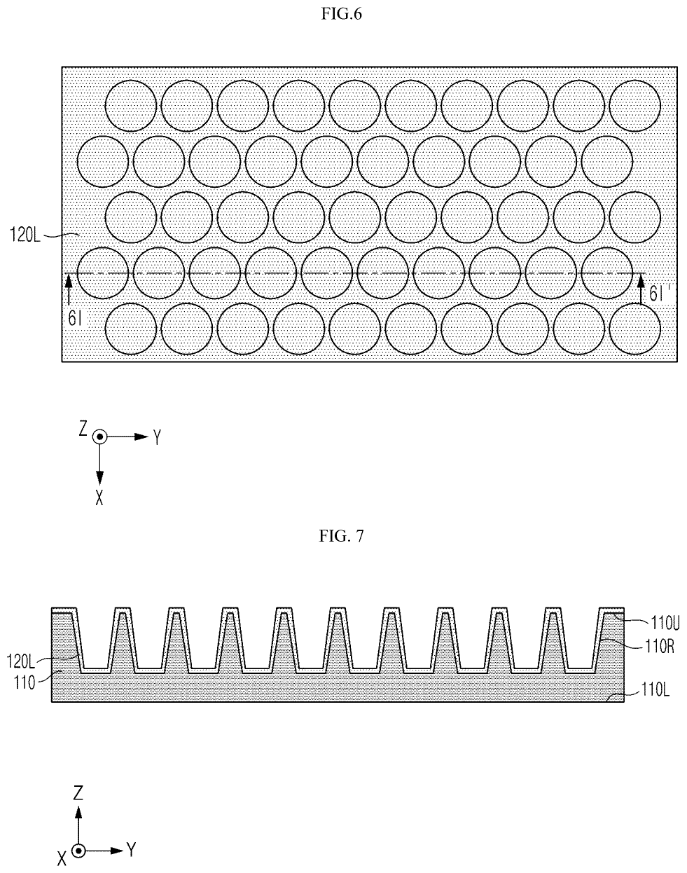

FIG. 6 is top a plan view illustrating a step of a method of manufacturing an integrated battery according to aspects.

FIG. 7 is a cross-sectional view taken along line 6I-6I′ of FIG. 6.

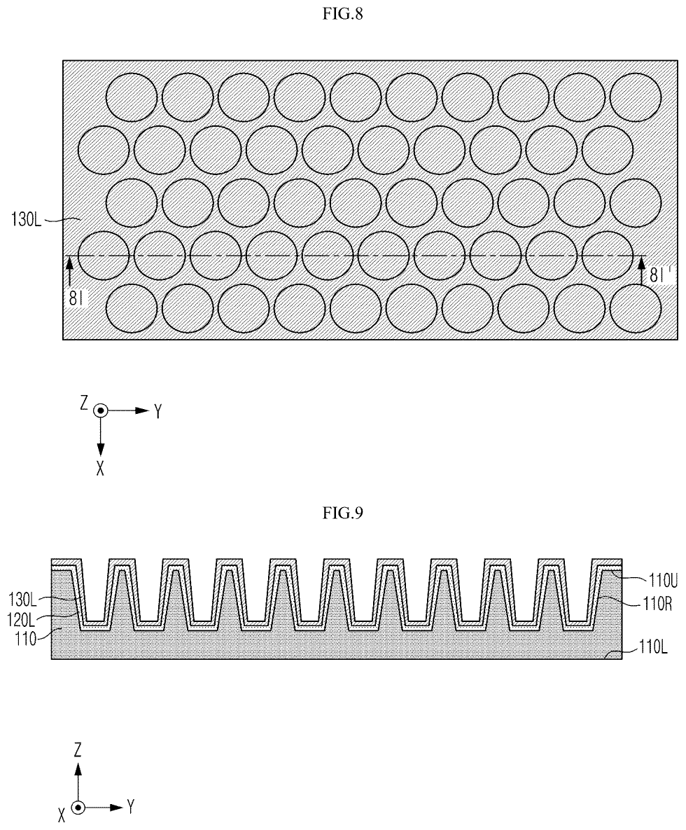

FIG. 8 is a top plan view illustrating a step of a method of manufacturing an integrated battery according to aspects.

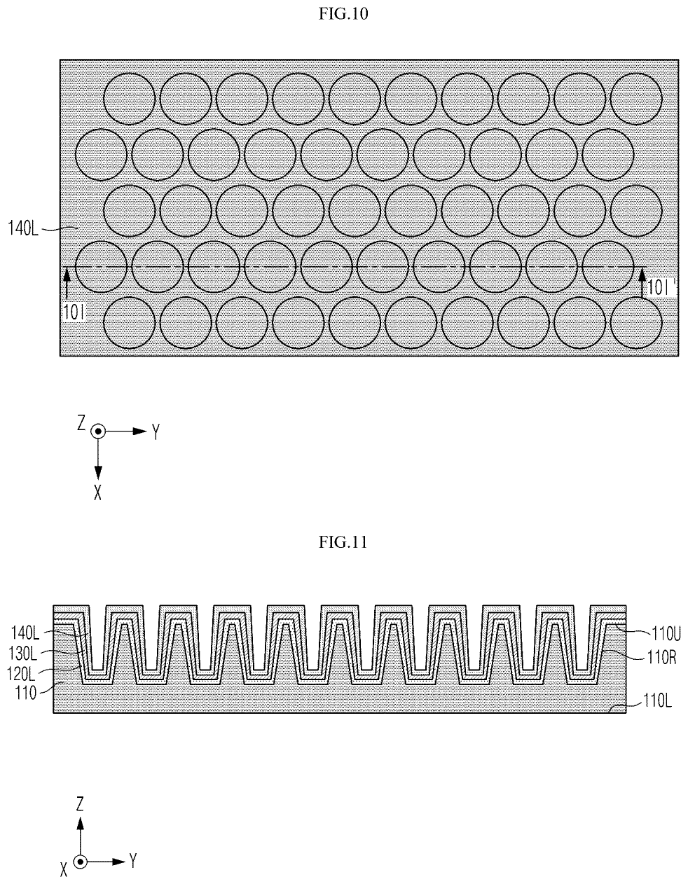

FIG. 9 is a cross-sectional view taken along line 8I-8I′ of FIG. 8.

FIG. 10 is a top plan view illustrating a step of a method of manufacturing an integrated battery according to aspects.

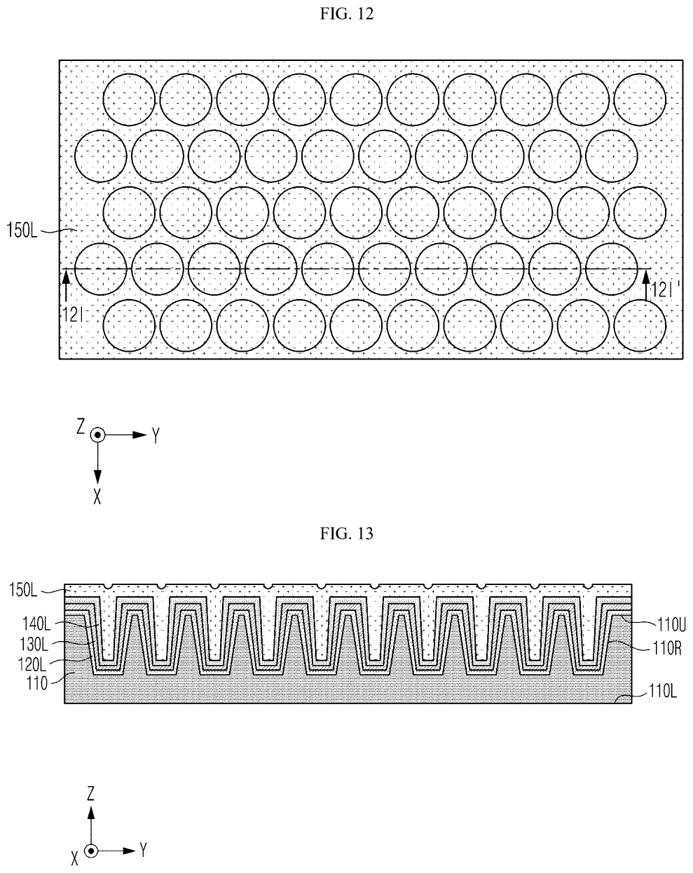

FIG. 11 is a cross-sectional view taken along line 10I-10I′ of FIG. 10.

FIG. 12 is a top plan view illustrating a step of a method of manufacturing an integrated battery according to aspects.

FIG. 13 is a cross-sectional view taken along line 12I-12I′ of FIG. 12.

FIG. 14 is a top plan view illustrating a step of a method of manufacturing an integrated battery according to aspects.

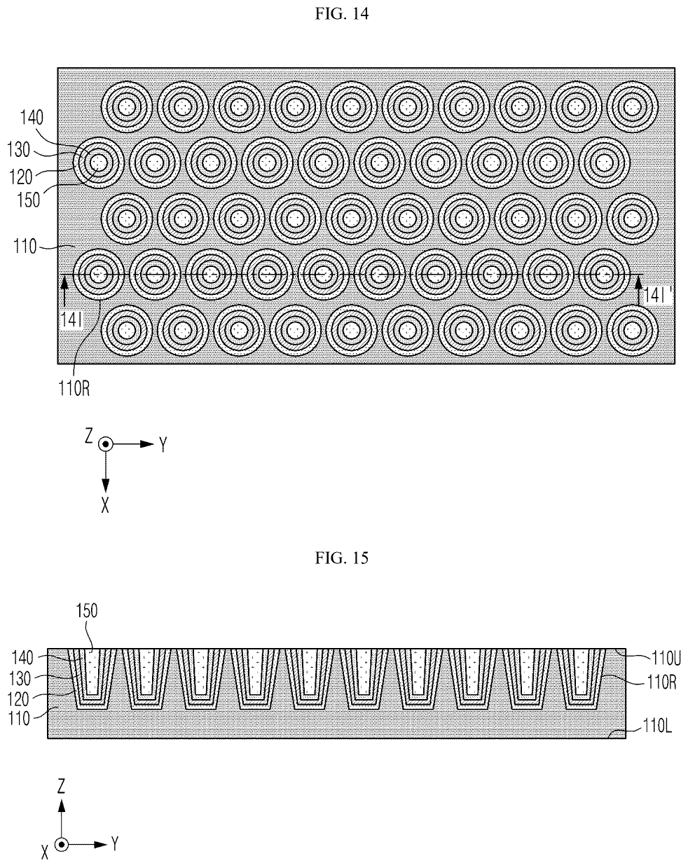

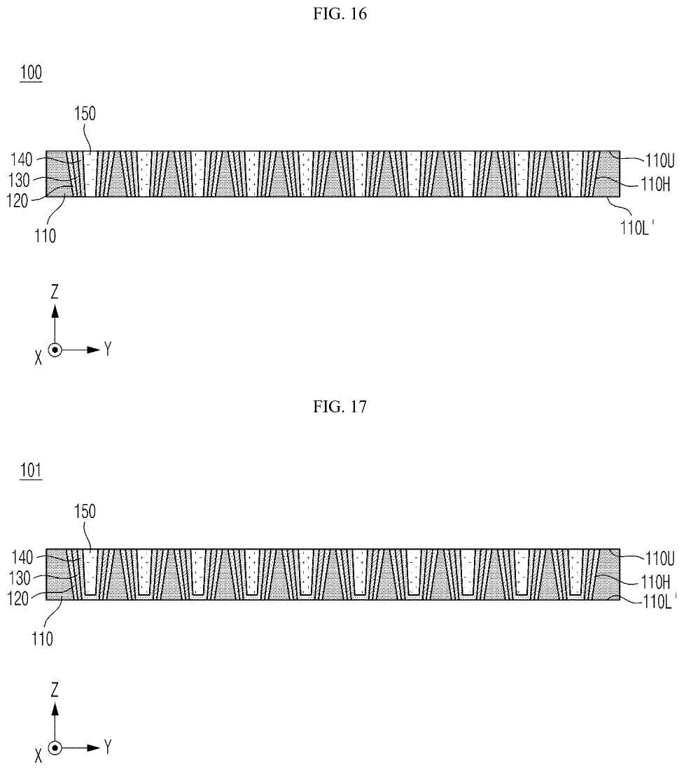

FIG. 15 is a cross-sectional view taken along line 14I-14I′ of FIG. 14.

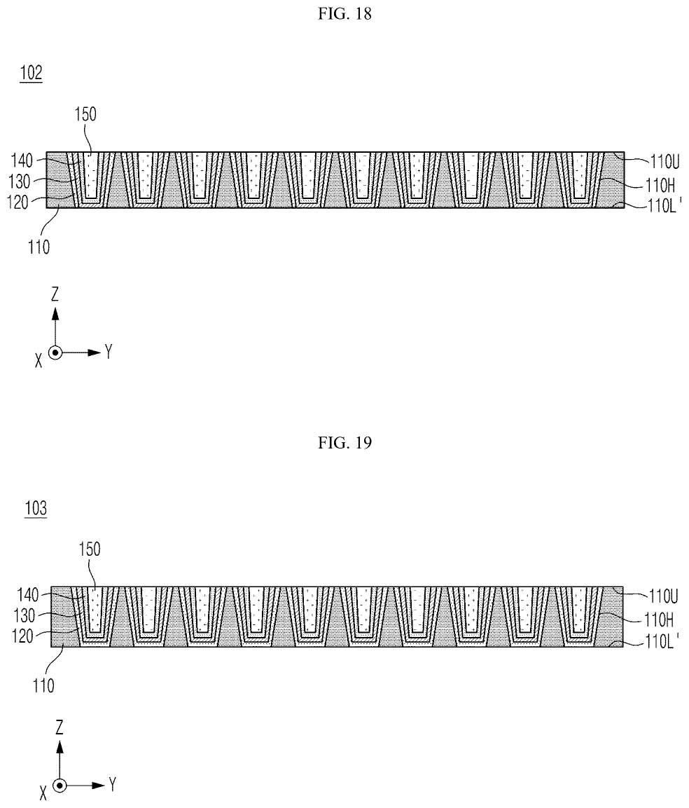

FIG. 16 is a cross-sectional view of an integrated battery according to aspects.

Referring to FIGS. 1 to 3, in step P110 of the method of manufacturing an integrated battery of FIG. 1, a substrate 110 may be provided. The substrate 110 may comprise a first surface and a second surface opposite the first surface in the substrate thickness direction, i.e., the Z-axis direction. The first surface and the second surface may be an upper surface 110U and a lower surface 110L of the substrate 110, respectively. A thickness of the substrate 110 refers to an average distance from the first surface of the substrate 110 to the second surface of the substrate in the substrate thickness direction.

Two directions substantially parallel to an upper surface 110U of the substrate 110 will be defined as an X-axis direction and a Y-axis direction, and a direction substantially perpendicular to the X-axis direction and the Y-axis direction will be defined as a Z-axis direction. The X-axis direction, the Y-axis direction, and the Z-axis direction may be substantially perpendicular to one another.

The substrate 110 may comprise a first material. According to aspects, the first material of the substrate 110 may include diamond, SiC, GaN, Bi₂O₃/GeO₂, Sm₂O₃/Bi₂O₃/GeO₂, Sm₂O₃/Bi₂O₃/B₂O₃, Sm₂O₃/Bi₂O₃/GeO₂/B₂O₃, or sapphire.

The first material of the substrate 110 may be processed by ion implantation or ion diffusion. The first material of the substrate 110 may be doped with a first conductivity type dopant. The first conductivity type dopant may be a p-type dopant or an n-type dopant.

The p-type dopant may include at least one of boron (B), aluminum (Al), gallium (Ga), or indium (In). In some aspects, the p-type dopants may include beryllium (Be), magnesium (Mg), or zinc (Zn). The n-type dopant may include at least one of nitrogen (N), phosphorus (P), arsenic (As), or antimony (Sb). In some aspects, the n-type dopants may include silicon (Si), germanium (Ge), or tellurium (Te).

The first material of the substrate 110 may include a metal oxide with band gap energy of 2.7 eV or more. In some aspects, the first material of the substrate 110 may include a material represented by AMO₃ where, A is at least one element selected from La, Ba, Sr, or K, and M is at least one element selected from Al, In, Ga, Ti, Sn, Hf, Ta, or Zr.

For example, the first material of the substrate 110 may include at least one of BaSnO₃, BaHfO₃, BaZrO₃, BaHf₁₋ₓTiₓO₃ (where, 0<x<1), Ba₁₋ₓLaₓSnO₃ (where, 0<x<1), Bi₄Ge₃O₁₂, Al₂O₃, Y₂O₃, La₂O₃, Ga₂O₃, Bi₂O₃, ZrO₂, HfO₂, Ta₂O₅, TiO₂, LaInO₃, LaGaO₃, SrZrO₃, SrHfO₃, SrTaO₇, LaIn₁₋ₓGaₓO₃ (where, 0<x<1), LaGaO₃, SrTiO₃, KTaO₃, HfSiO₄, Ta₃Ti₂Oₓ (where, 0<x<1), or LaAlO₃.

Referring now to FIGS. 1, 4 and 5, in step P120 of the method of manufacturing an integrated battery illustrated in FIG. 1, the substrate 110 may be patterned. As described herein, patterning the substrate 110 may include removing material from a surface of the substrate 110 to form a plurality of recesses 110R in the substrate 110. The plurality of recesses 110R may be formed in the upper surface 110U or the lower surface 110L of the substrate. In the aspect depicted in FIGS. 4 and 5, the plurality of recesses 110R are formed in the upper surface 110U of the substrate 110. The plurality of recesses 110R may be in any suitable arrangement or pattern.

The substrate 110 may be patterned by reactive ion etching (RIE) including low-temperature etching or ion beam etching. The substrate 110 may be patterned by laser beams. The substrate 110 may be patterned by anisotropic wet etching.

Before the substrate 110 is patterned, a mask may be deposited on at least a portion of the first surface or the second surface of the substrate 110. The mask may be formed by photolithography. The mask may expose a portion of the substrate 110. The portion of the substrate 100 exposed by the mask may be etched to form a plurality of recesses 110R. The mask may cover a non-etched portion of the substrate 110 i.e., a portion of the substrate 100 between the plurality of recesses 110R. A hard mask may be additionally provided between the mask and the substrate 110.

The plurality of recesses 110R may be formed by etching the substrate 110. According to one or more aspects, the plurality of recesses 110R may have a circular shape when viewed from above. When the plurality of recesses 110R have the circular shape when viewed from above, the plurality of recesses 110R may have a circular cross-sectional shape in a plane normal to the Z-axis direction.

According to one or more aspects, the plurality of recesses 110R may be arranged in a honeycomb structure, also known as a hexagonal lattice. It may be understood that when the plurality of recesses 110R are arranged in the honeycomb structure, centers RC of the plurality of recesses 110R are at the vertices and centers of a plurality of regular hexagons that have the same size and fill a plane.

Each of the plurality of recesses 110R may have a variable width in the X-axis direction, the Y-axis direction, or both the X and Y-axis directions at different positions along the Z-axis direction. For example, a cross-sectional area of each of the plurality of recesses 110R in a plane extending the X-axis direction and the Y-axis direction may vary along the Z-axis direction. In a specific aspect, each of the plurality of recesses 110R may have a tapered shape in the Z-axis direction. Each of the plurality of recesses 110R may extend from the upper surface 110U of the substate 100 in the Z-axis direction into a body of the substrate 100. In one or more aspects, the cross-sectional area of each of the plurality of recesses 110R may decrease as a distance from the upper surface 110U of the substrate 100 increases. A first cross-sectional area of each of the plurality of recesses 110R at a first depth from the upper surface 110U of the substrate 100 may be less than a second cross-sectional area of each of the plurality of recesses 110R at a second depth from the upper surface of the substrate 110, when the second depth is less than the first depth.

Referring now to FIGS. 1, 6 and 7, in step P130 of the method of manufacturing an integrated battery illustrated in FIG. 1, a second material layer 120L may be formed. The second material layer 120L may have a uniform thickness. In one or more aspects, the second material layer 120L may have a conformal shape to the substrate 110. It may be understood that when the second material layer 120L has the conformal shape, a shape of a structure onto which the second material layer 120L is formed (i.e., the substrate 110 and the plurality of recesses 110R) is transferred to the shape of the second material layer 120L.

The second material layer 120L may be formed by depositing it onto the substrate 110 by a process such as chemical vapor deposition (CVD) or physical vapor deposition (PVD) but is not limited thereto. The second material layer 120L may be formed by oxidation of a metal layer formed by metal CVD.

The second material of the second material layer 120L may include a metal oxide with band gap energy of 2.7 eV or more. In some aspects, the second material of the second material layer 120L may include a material represented by AMO₃ where, A is at least one element selected from La, Ba, Sr, or K, and M is at least one element selected from Al, In, Ga, Ti, Sn, Hf, Ta, or Zr.

For example, the second material of the second material layer 120L may include at least one of BaSnO₃, BaHfO₃, BaZrO₃, BaHf₁₋ₓTiₓO₃ (where, 0<x<1), Ba₁₋ₓLaₓSnO₃ (where, 0<x<1), Bi₄Ge₃O₁₂, Al₂O₃, Y₂O₃, La₂O₃, Ga₂O₃, Bi₂O₃, ZrO₂, HfO₂, Ta₂O₅, TiO₂, LaInO₃, LaGaO₃, SrZrO₃, SrHfO₃, SrTaO₇, LaIn₁₋ₓGaₓO₃ (where, 0<x<1), LaGaO₃, SrTiO₃, KTaO₃, HfSiO₄, Ta₃Ti₂Oₓ (where, 0<x<1), or LaAlO₃.

The second material layer 120L is stable even in high-temperature and high-humidity environments and has high carrier mobility. Additionally, carrier movement in the second material layer 120L does not show inelastic collision. Accordingly, an integrated battery comprising the second material layer 120L may have high energy efficiency and excellent heat dissipation characteristics.

According to one or more aspects, carrier mobility in the second material layer 120L may be about 45 cm²/(V·s) or more. According to one or more aspects, carrier mobility in the second material layer 120L may be about 80 cm²/(V·s) or more. According to one or more aspects, carrier mobility in the second material layer 120L may be about 120 cm²/(V·s) or more. According to some aspects, carrier mobility in the second material layer 120L may be about 300 cm²/(V·s) or more.

The second material of the second material layer 120L may include a doped semiconductor material, a compound semiconductor, an oxide semiconductor, or a metal alloy. According to one or more aspects, the second material of the second material layer 120L may include boron (B)-doped silicon (Si), silicon (Si) doped with one of phosphorus (P) or arsenic (As), zinc (Zn)-doped gallium arsenide (GaAs), gallium arsenide (GaAs) doped with one of silicon (Si) or tellurium (Te), boron (B)-doped germanium (Ge), germanium (Ge) doped with one of phosphorus (P) or antimony (Sb), magnesium (Mg)-doped gallium nitride (GaN), silicon (Si)-doped gallium nitride (GaN), silicon carbide (SiC) doped with one of aluminum (Al) or boron (B), silicon carbide (SiC) doped with one of nitrogen (N) or phosphorus (P), zinc (Zn)-doped indium phosphide (InP), indium phosphide (InP) doped with one of sulfur (S) or silicon (Si), cadmium telluride (CdTe), cadmium sulfide (CdS), tin oxide (SnO), or zinc oxide (ZnO).

The second material of the second material layer 120L may be doped with a second conductivity type dopant. The second conductivity type dopant may have a conductivity opposite to a conductivity of first conductivity type dopant. For example, the second conductivity type dopant may be an n-type dopant when the first conductivity type dopant is a p-type dopant, or the second conductivity type dopant may be the p-type dopant when the first conductivity type dopant is the n-type dopant. Accordingly, a pn junction may be formed at an interface between the first material of the substrate 110 and the second material of the second material layer 120L. Additionally, a depletion region due to the pn junction may be formed between the first material of the substrate 110 and the second material of the second material layer 120L.

Referring now to FIGS. 1, 8 and 9, in step P140 of the method of manufacturing an integrated battery of FIG. 1, a radiation source layer 130L may be formed. The radiation source layer 130L may be formed by evaporation, sputtering, CVD, electroplating, or electroless plating. The radiation source layer 130L may have a uniform thickness. In one or more aspects, the radiation source layer 130L may have a conformal shape to the second material layer 120L. When the radiation source layer 130L is formed by electroplating or electroless plating, a seed layer may be formed between the radiation source layer 130L and the second material layer 120L.

The radiation source layer 130L may include a radioactive isotope. The radiation source layer 130L may be configured to emit radiation. The radiation source layer 130L may include, for example, a radioactive isotope that emits beta rays. The radiation source layer 130L may include at least one of tritium (³H), calcium-45 (⁴⁵Ca), nickel-63 (⁶³Ni), copper-67 (⁶⁷Cu), strontium-90 (⁹⁰Sr), promethium-147 (¹⁴⁷Pm), osmium-194 (¹⁹⁴OS), thulium-171 (¹⁷¹Tm), tantalum-179 (¹⁷⁹Ta), cadmium-109 (¹⁰⁹Cd), germanium-68 (⁶⁸Ge), cerium-159 (¹⁵⁹Ce), or tungsten-181 (¹⁸¹W). The radioactive isotope may emit only beta rays or may emit beta rays along with alpha rays, gamma rays, or the like.

In some aspects, the radiation source layer 130L may include a radioactive isotope that emits alpha rays. For example, the radiation source layer 130L may include one or more of americium-241 (²⁴¹Am), americium-243 (²⁴³Am), polonium-209 (²⁰⁹Po), polonium-210 (²¹⁰Po), plutonium-238 (²³⁸Pu), plutonium-239 (²³⁹Pu), curium-242 (²⁴²Cm), curium-244 (²⁴⁴Cm), curium-249 (²⁴⁹Cm), promethium-147 (¹⁴⁷Pm), uranium-238 (²³⁸U), thorium-232 (²³²Th), radium-226 (²²⁶Ra), bismuth-210 (²¹⁰Bi), neptunium-237 (²³⁷Np), europium-152 (¹⁵²Eu), francium-223 (²²³Fr), astatine-210 (²¹⁰At), protactinium-231 (²³¹Pa), einsteinium-253 (²⁵³Es), californium-252 (²⁵²Cf), or berkelium-249 (²⁴⁹Bk). However, aspects of the present disclosure are not limited to these.

Referring now to FIGS. 1, 10 and 11, in step P150 of the method of manufacturing an integrated battery of FIG. 1, a third material layer 140L may be formed. The third material 140L may be formed by CVD or epitaxial growth. The third material layer 140L may have a uniform thickness. In one or more aspects, the third material layer 140L may have a conformal shape to the radiation source layer 130L.

The third material of the third material layer 140L may be doped with a dopant. The dopant may be an n-type dopant or a p-type dopant. In one or more aspects, the dopant may be introduced into the third material layer 140L during the growth of the third material layer 140L. In one or more aspects, the third material layer 140L may be doped with the dopant by ion implantation and diffusion after the third material layer 140L is formed.

According to aspects, the third material layer 140L may be spaced apart from the second material layer 120L. In one or more aspects, the radiation source layer 130L may be between the second material layer 120L and the third material layer 140L.

Referring now to FIGS. 1, 12, and 13, in step P160 of the method of manufacturing an integrated battery of FIG. 1, a fourth material layer 150L may be formed. The fourth material layer 150L may be formed by CVD or epitaxial growth. The fourth material of the fourth material layer 150L may be doped with the a dopant. The dopant may be a p-type dopant or an n-type dopant. In one or more aspects, the dopant may be introduced into the fourth material layer 150L during the growth of the fourth material layer 150L. In some aspects, the fourth material layer 150L may be doped with the dopant by ion implantation and diffusion after the fourth material layer 150L is formed. The fourth material layer 150L may fill the recesses 110R. Each of the third material of the third material layer 140L and the fourth material of the fourth material layer 150L may include a doped semiconductor material, a compound semiconductor, an oxide semiconductor, or a metal alloy.

The fourth material of the fourth material layer 150L may be doped with a dopant having a polarity opposite to that of the dopant of the third material of the third material layer 140L. Accordingly, the polarity of the fourth material layer 150L may be opposite to that of the third material layer 140L. In one or more aspects, a pn junction may be formed at an interface between the third material layer 140L and the fourth material layer 150L. In one or more aspects, a depletion region may be formed at an interface between the fourth material layer 150L and the third material layer 140L.

According to aspects, the third material of the third material layer 140L may include silicon (Si) doped with boron (B), and the fourth material of the fourth material layer 150L may include silicon (Si) doped with phosphorus (P) or arsenic (As).

According to aspects, the third material of the third material layer 140L may include silicon (Si) doped with phosphorus (P) or arsenic (As), and the fourth material of the fourth material layer 150L may include silicon (Si) doped with boron (B).

According to aspects, the third material of the third material layer 140L may include gallium arsenic (GaAs) doped with zinc (Zn), and the fourth material of the fourth material layer 150L may include gallium arsenic (GaAs) doped with silicon (Si) or tellurium (Te).

According to aspects, the third material of the third material layer 140L may include gallium arsenic (GaAs) doped with silicon (Si) or tellurium (Te), and the fourth material of the fourth material layer 150L may include gallium arsenic (GaAs) doped with zinc (Zn).

According to aspects, the third material of the third material layer 140L may include germanium (Ge) doped with boron (B), and the fourth material of the fourth material layer 150L may include germanium (Ge) doped with phosphorus (P) or antimony (Sb).

According to aspects, the third material of the third material layer 140L may include germanium (Ge) doped with phosphorus (P) or antimony (Sb), and the fourth material of the fourth material layer 150L may include germanium (Ge) doped with boron (B).

According to aspects, the third material of the third material layer 140L may include gallium nitride (GaN) doped with magnesium (Mg), and the fourth material of the fourth material layer 150L may include gallium nitride (GaN) doped with silicon (Si).

According to aspects, the third material of the third material layer 140L may include gallium nitride (GaN) doped with silicon (Si), and the fourth material of the fourth material layer 150L may include gallium nitride (GaN) doped with magnesium (Mg).

According to aspects, the third material of the third material layer 140L may include silicon carbide (SiC) doped with aluminum (Al) or boron (B), and the second material of the second material layer 150L may include silicon carbide (SiC) doped with nitrogen (N) or phosphorus (P).

According to aspects, the third material of the third material layer 140L may include silicon carbide (SiC) doped with nitrogen (N) or phosphorus (P), and the fourth material of the fourth material layer 150L may include silicon carbide (SiC) doped with aluminum (Al) or boron (B).

According to aspects, the third material of the third material layer 140L may include indium phosphide (InP) doped with zinc (Zn), and the fourth material of the fourth material layer 150L may include indium phosphide (InP) doped with sulfur (S) or silicon (Si).

According to aspects, the third material of the third material layer 140L may include indium phosphide (InP) doped with sulfur (S) or silicon (Si), and the fourth material of the fourth material layer 150L may include indium phosphide (InP) doped with zinc (Zn).

According to aspects, the third material of the third material layer 140L may include cadmium telluride (CdTe), and the fourth material of the fourth material layer 150L may include cadmium sulfide (CdS).

According to aspects, the third material of the third material layer 140L may include cadmium sulfide (CdS), and the fourth material of the fourth material layer 150L may include cadmium telluride (CdTe).

According to aspects, the third material of the third material layer 140L may include tin oxide (SnO), and the fourth material of the fourth material layer 150L may include zinc oxide (ZnO).

According to aspects, the third material of the third material layer 140L may include zinc oxide (ZnO), and the fourth material of the fourth material layer 150L may include tin oxide (SnO).

According to aspects, the third material of the third material layer 140L may be of the same conductivity type as the first material of the substrate 110, and the fourth material of the fourth material layer 150L may be of the same conductivity type as the second material of the second material layer 120L. For example, the third material of the third material layer 140L and the first material of the substrate 110 may be doped with the n-type dopant, and the fourth material of the fourth material layer 150L and the second material of the second material layer 120L may be doped with the p-type dopant. As another example, the third material of the third material layer 140L and the first material of the substrate 110 may be doped with the p-type dopant, and the fourth material of the fourth material layer 150L and the second material of the second material layer 120L may be doped with the n-type dopant.

According to other aspects, the third material of the third material layer 140L may be of the same conductivity type as the second material of the second material layer 120L, and the fourth material of the fourth material layer 150L may be of the same conductivity type as the first material of the substrate 110. For example, the third material of the third material layer 140L and the second material of the second material layer 120L may be doped by the n-type dopant, and the fourth material of the fourth material layer 150L and the first material of the substrate 110 may be doped by the p-type dopant. As another example, the third material of the third material layer 140L and the second material of the second material layer 120L may be doped by the p-type dopant, and the fourth material of the fourth material layer 150L and the first material of the substrate 110 may be doped by the n-type dopant.

Referring now to FIGS. 1 and 13 to 15, in step P170 of the method of manufacturing an integrated battery of FIG. 1, a first chemical mechanical polishing (CMP) process may be performed. In one or more aspects, the first CMP process may remove at least a portion of the fourth material layer 150L. In one or more aspects, the first CMP process may remove at least a portion of the third material layer 140L. In one or more aspects, the first CMP process may remove at least a portion of the radiation source layer 130L. In one or more aspects, the first CMP process may remove at least a portion of the second material layer 120L. In some aspects, the upper surface 110U of the substrate 110 may be an end point of the first CMP process. A change in reflectance inside a CMP chamber or a change in the concentration of a specific chemical component may be used to determine the end point of the CMP process.

The first CMP process may divide the second material layer 120L into a plurality of second material patterns 120. As described herein, the term “layer” generally refers to a continuous film formed by a deposition process, and the term “pattern” generally refers to a structure obtained by subsequently processing such a layer, for example by etching or CMP. The first CMP process may divide the radiation source layer 130L into a plurality of radiation sources 130. The first CMP process may divide the third material layer 140L into a plurality of third material patterns 140. The first CMP process may divide the fourth material layer 150L into a plurality of fourth material patterns 150. An upper surface of each of the plurality of second material patterns 120, an upper surface of each of the plurality of radiation sources 130, an upper surface of each of the plurality of second material patterns 140, and an upper surface of each of the plurality of fourth material patterns 150 may be coplanar with the upper surface 110U of the substrate 110.

Referring now to FIGS. 1, 15, and 16, in step P180 of the method of manufacturing an integrated battery of FIG. 1, a second CMP process may be performed. The second CMP process may remove at least a portion of the substrate 110. In one or more aspects, the second CMP process may remove at least a portion of each of the plurality of second material patterns 120. In one or more aspects, the second CMP process may remove at least a portion of each of the plurality of radiation sources 130. In one or more aspects, the second CMP process may remove at least a portion of each of the plurality of third material patterns 140. In one or more aspects, the second CMP process may remove at least a portion of each of the plurality of fourth material patterns 150. In one or more aspects, the plurality of fourth material patterns 150 may be an end point of the second CMP process. An integrated battery 100 including the substrate 110, the plurality of second material patterns 120, the plurality of radiation sources 130, the plurality of third material patterns 140, and the plurality of fourth material patterns 150 may be formed by the second CMP process.

The plurality of recesses 110R may become a plurality of holes 110H extending to a new lower surface 110L′ of the substrate 110 by the second CMP process. Each of the plurality of holes 110H may penetrate the substrate 110. A lower surface of each of the plurality of second material patterns 120, a lower surface of each of the plurality of radiation sources 130, a lower surface of each of the plurality of third material patterns 140, and a lower surface of each of the plurality of fourth material patterns 150 may be coplanar with the lower surface 110L′ of the substrate 110.

According to aspects, the substrate 110 may include a plurality of holes 110H having a tapered shape. Each of the plurality of holes 110H may extend in the Z-axis direction perpendicular to the upper surface 110U of the substrate 110. Each of the plurality of holes 110H may penetrate the substrate 110. Each of the plurality of holes 110H may have an opening at an upper surface 110U of the substrate 110 and an opening at the lower surface 110L′ of the substrate 110. In one or more aspects, a cross-sectional area of the opening at the upper surface 110U of the substrate may be greater than a cross-sectional area of the opening at the lower surface 110L′ of the substrate 110.

Each of the plurality of second material patterns 120 may be in contact with the substrate 110. In one or more aspects, each of the plurality of second material patterns 120 may be in direct contact with the substrate 110. The plurality of second material patterns 120 may have polarity opposite to a polarity of the substrate 110. Each of the plurality of second material patterns 120 may be between the substrate 110 and a corresponding one of the plurality of radiation sources 130. In one or more aspects, each of the plurality of second material patterns 120 may directly contact the substrate 110 and one of the plurality of radiation sources 130. Each of the plurality of second material patterns 120 may have a uniform thickness.

Each of the plurality of radiation sources 130 may be in a corresponding one of the plurality of holes 110H. Each of the plurality of radiation sources 130 may be between a corresponding one of the plurality of second material patterns 120 and a corresponding one of the plurality of third material patterns 140. In one or more aspects, each of the plurality of radiation sources 130 may be in direct contact with a corresponding one of the plurality of second material patterns 120 and a corresponding one of the plurality of third material patterns 140. Each of the plurality of radiation sources 130 may have a uniform thickness. Each of the plurality of radiation sources 130 may be at least partially surrounded by a corresponding one of the plurality of second material patterns 120.

Each of the plurality of third material patterns 140 may be in a corresponding one of the plurality of holes 110H. Each of the plurality of third material patterns 140 may be between a corresponding one of the plurality of radiation sources 130 and a corresponding one of the plurality of fourth material patterns 150. In one or more aspects, each of the plurality of third material patterns 140 may be in direct contact with a corresponding one of the plurality of radiation sources 130 and a corresponding one of the plurality of fourth material patterns 150. Each of the plurality of third material patterns 140 may have a uniform thickness. Each of the plurality of third material patterns 140 may be at least partially surrounded by a corresponding one of the plurality of radiation sources 130. Each of the plurality of third material patterns 140 may be spaced apart from a corresponding one of the plurality of second material patterns 120 with a corresponding one of the plurality of radiation sources 130 interposed therebetween.

Each of the plurality of fourth material patterns 150 may be in a corresponding one of the plurality of holes 110H. Each of the plurality of fourth material patterns 150 may have a tapered shape. Each of the plurality of fourth material patterns 150 may be at least partially surrounded by a corresponding one of the plurality of third material patterns 140. In one or more aspects, each of the plurality of fourth material patterns 150 may directly contact a corresponding one of the plurality of third material patterns 140.

Each of the plurality of radiation sources 130 may be configured to emit beta rays. A depletion region between the substrate 110 and the plurality of second material patterns 120 to which beta rays are emitted may be configured to generate an electron-hole pair to produce an electromotive force. A depletion region between the plurality of third material patterns 140 and the plurality of fourth material patterns 150 to which beta rays are emitted may be configured to generate an electron-hole pair to produce an electromotive force.

According to aspects, the plurality of radiation sources 130 partially fill the plurality of holes 110H to reduce the amount of material used to form the plurality of radiation sources 130. This may reduce manufacturing costs of the integrated battery 100. In addition, a pn junction and a depletion region may be formed on each of an outer side and an inner side of each of the plurality of radiation sources 130 to increase a utilization rate of beta particles emitted from the plurality of radiation sources 130. This may improve the energy efficiency of the integrated battery 100.

According to aspects, each radiation source of the plurality of radiation sources 130 may include a first surface and a second surface. The first surface of the radiation source may be opposite to the second surface of the radiation source. The first surface of each radiation source of the plurality of radiation sources 130 may face the substrate 110. A doped diamond substrate, a doped SiC substrate, a doped GaN substrate, a doped Bi₂O₃/GeO₂ substrate, a doped Sm₂O₃/Bi₂O₃/GeO₂ substrate, a doped Sm₂O₃/Bi₂O₃/B₂O₃ substrate, a doped Sm₂O₃/Bi₂O₃/GeO₂/B₂O₃ substrate, or a doped sapphire substrate may be on the first surface of each radiation source of the plurality of radiation sources 130.

In one or more aspects, a material containing a metal oxide with bandgap energy of 2.7 eV or more may be on the first surface of each radiation source of the plurality of radiation sources 130. A material represented by AMO₃ where, A is at least one element selected from La, Ba, Sr, or K, and M is at least one element selected from Al, In, Ga, Ti, Sn, Hf, Ta, or Zr may be on the first surface of each radiation source of the plurality of radiation sources 130. In one or more aspects, a material containing at least one of BaSnO₃, BaHfO₃, BaZrO₃, BaHf₁₋ₓTiₓO₃ (where, 0<x<1), Ba₁₋ₓLaₓSnO₃ (where, 0<x<1), Bi₄Ge₃O₁₂, Al₂O₃, Y₂O₃, La₂O₃, Ga₂O₃, Bi₂O₃, ZrO₂, HfO₂, Ta₂O₅, TiO₂, LaInO₃, LaGaO₃, SrZrO₃, SrHfO₃, SrTaO₇, LaIn₁₋ₓGaₓO₃ (where, 0<x<1), LaGaO₃, SrTiO₃, KTaO₃, HfSiO₄, Ta₃Ti₂Oₓ (where, 0<x<1), or LaAlO₃ may be on the first surface of each radiation source of the plurality of radiation sources 130.

In one or more aspects, a material containing at least one of silicon (Si) doped with boron (B), silicon (Si) doped phosphorus (P) or arsenic (As), gallium arsenic (GaAs) doped with zinc (Zn), gallium arsenic (GaAs) doped with silicon (SI) or tellurium (Te), germanium (Ge) doped with boron (B), germanium (Ge) doped with phosphorus (P) or antimony (Sb), gallium nitride (GaN) doped with magnesium (Mg), gallium nitride (GaN) doped with silicon (Si), silicon carbide (SiC) doped with aluminum (Al) or boron (B), silicon carbide (SiC) doped with nitrogen (N) or phosphorus (P), indium phosphate (InP) doped with zinc (Zn), indium phosphate (InP) doped with sulfur (S) or silicon (Si), cadmium telluride (CdTe), cadmium sulfide (CdS), tin oxide (SnO), or zinc oxide (ZnO) may be on the second surface of each radiation source of the plurality of radiation sources 130.

### Third Aspect

FIG. 17 is a cross-sectional view of an integrated battery 101 according to an aspect.

Referring to FIG. 17, the integrated battery 101 may include a substrate 110, a plurality of second material patterns 120, a plurality of radiation sources 130, a plurality of third material patterns 140, and a plurality of fourth material patterns 150.

The integrated battery 101 of FIG. 17 may be formed by setting a lower surface of each of the plurality of third material patterns 140 as the end point of the second CMP process in step P180 of the method of manufacturing an integrated battery of FIG. 1. In such aspects, a lower surface of each of the plurality of second material patterns 120, a lower surface of each of the plurality of radiation sources 130, and the lower surface of each of the plurality of third material patterns 140 may be coplanar with a lower surface 110L′ of the substrate 110. A lower surface of each of the plurality of fourth material patterns 150 may be spaced apart from the lower surface 110L′ of the substrate 110. Each of the plurality of third material patterns 140 may have a cup shape.

### Fourth Aspect

FIG. 18 is a cross-sectional view of an integrated battery 102 according to an aspect.

Referring to FIG. 18, the integrated battery 102 may include a substrate 110, a plurality of second material patterns 120, a plurality of radiation sources 130, a plurality of third material patterns 140, and a plurality of fourth material patterns 150.

The integrated battery 102 of FIG. 18 may be formed by setting a lower surface of each of the plurality of radiation sources 130 as an end point of the second CMP process in step P180 of the method of manufacturing an integrated battery of FIG. 1. In such aspects, a lower surface of each of the plurality of second material patterns 120 and the lower surface of each of the plurality of radiation sources 130 may be coplanar with a lower surface 110L′ of the substrate 110. A lower surface of each of the plurality of fourth material patterns 150 may be spaced apart from the lower surface 110L′ of the substrate 110. A lower surface of each of the plurality of third material patterns 140 may be spaced apart from the lower surface 110L′ of the substrate 110.

Each of the plurality of radiation sources 130 may have a cup shape. Each of the plurality of third material patterns 140 may have a cup shape.

### Fifth Aspect

FIG. 19 is a cross-sectional view of an integrated battery 103 according to an aspect.

Referring to FIG. 19, the integrated battery 103 may include a substrate 110, a plurality of second material patterns 120, a plurality of radiation sources 130, a plurality of third material patterns 140, and a plurality of fourth material patterns 150.

The integrated battery 103 of FIG. 19 may be formed by setting a lower surface of each of the plurality of second material patterns 120 as an end point of the second CMP process in step P180 of the method of manufacturing an integrated battery of FIG. 1. In such aspects, the lower surface of each of the plurality of second material patterns 120 may be coplanar with a lower surface 110L′ of the substrate 110. A lower surface of each of the plurality of fourth material patterns 150 may be spaced apart from the lower surface 110L′ of the substrate 110. A lower surface of each of the plurality of third material patterns 140 may be spaced apart from the lower surface 110L′ of the substrate 110. A lower surface of each of the plurality of radiation sources 130 may be spaced apart from the lower surface 110L′ of the substrate 110.

Each of the plurality of second material patterns 220 may have a cup shape. Each of the plurality of radiation sources 130 may have a cup shape. Each of the plurality of third material patterns 140 may have a cup shape.

### Sixth Aspect

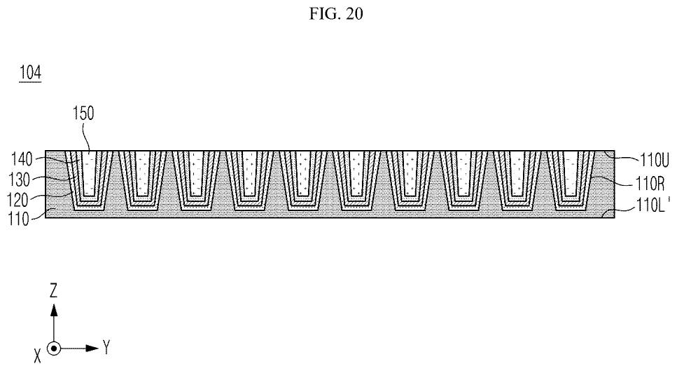

FIG. 20 is a cross-sectional view of an integrated battery 104 according to an aspect.

Referring to FIG. 20, the integrated battery 104 may include a substrate 110, a plurality of second material patterns 120, a plurality of radiation sources 130, a plurality of third material patterns 140, and a plurality of fourth material patterns 150.

The integrated battery 104 of FIG. 20 may be formed by setting a position within the substrate 110 that is spaced apart from a lower surface of each of the plurality of patterns 120 in the Z-axis direction as an end point of the second CMP process in step P180 of the method of manufacturing an integrated battery of FIG. 1. For example, the second CMP process may include removing material from the substrate 110 to achieve a target thickness for the substrate 110. In such aspects, the lower surface of each of the plurality of second material patterns 120 may be spaced apart from a lower surface 110L′ of the substrate 110. A lower surface of each of the plurality of fourth material patterns 150 may be spaced apart from the lower surface 110L′ of the substrate 110. A lower surface of each of the plurality of third material patterns 140 may be spaced apart from the lower surface 110L′ of the substrate 110. A lower surface of each of the plurality of radiation sources 130 may be spaced apart from the lower surface 110L′ of the substrate 110. The lower surface of the plurality of second material patterns 120 may be spaced apart from the lower surface 110L′ of the substrate 110.

Each of the plurality of second material patterns 220 may have a cup shape. Each of the plurality of radiation sources 130 may have a cup shape. Each of the plurality of third material patterns 140 may have a cup shape.

### Ninth Aspect

FIG. 21 is a plan view of an integrated battery 100a according to an aspect.

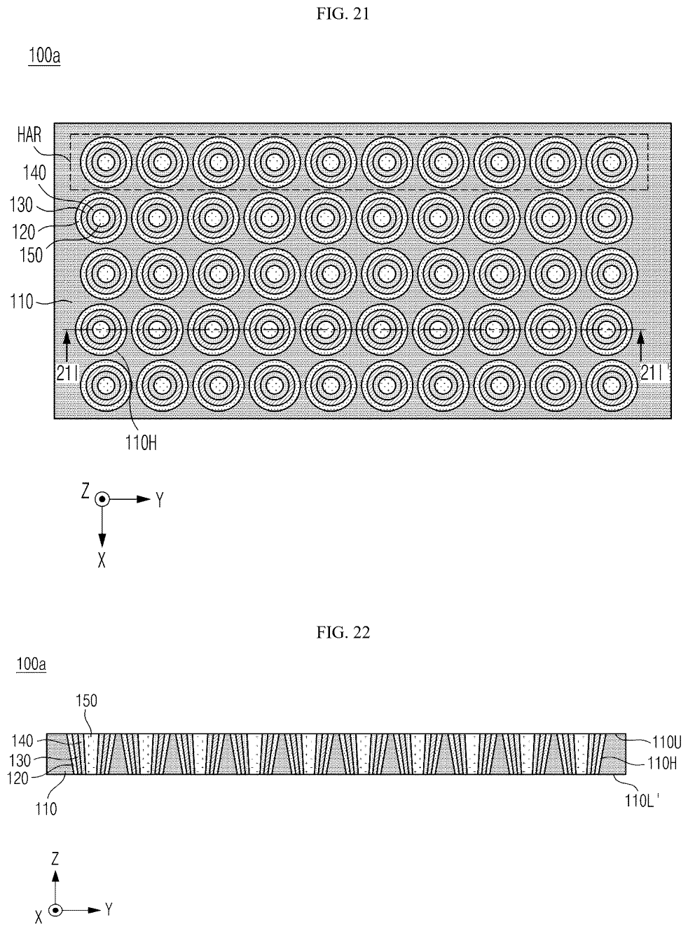

FIG. 22 is a cross-sectional view taken along line 21I-21I′ of FIG. 21.

Referring to FIGS. 21 and 22, the integrated battery 100a may include a substrate 110, a plurality of second material patterns 120, a plurality of radiation sources 130, a plurality of third material patterns 140, and a plurality of fourth material patterns 150.

The substrate 110, the plurality of second material patterns 120, the plurality of radiation sources 130, the plurality of third material patterns 140, and the plurality of fourth material patterns 150 are substantially the same as those described above with reference to FIGS. 1 to 16, except for an arrangement of a plurality of holes 110H. Thus, redundant description thereof is omitted here.

In the present aspect, the plurality of holes 110H may be arranged in a non-honeycomb structure, unlike the plurality of holes 110H of FIG. 16 that are arranged in the honeycomb structure. At least some of the centers of the plurality of holes 110H may be offset from positions for forming the honeycomb structure in the X-axis direction, in the Y-axis direction, or in both the X-axis direction and the Y-axis direction. In one or more aspects, a portion of the plurality of holes 110H may be arranged in an array. As described herein, a portion of the plurality of holes 110H are in an array when the portion of the plurality of holes are aligned in the X-axis direction or the Y-axis direction. For example, a portion of the plurality of holes 110H in hole array HAR are aligned along the Y-axis direction. When the integrated battery 100a comprises arrays of the plurality of holes 110H aligned along the Y-axis direction, neighboring hole arrays HARs in the X-axis direction may be staggered such that holes 110H in a first hole array are not aligned in the X-axis direction with holes 110H in an second hole array that is adjacent to the first hole array in the X-axis direction. In such aspects, the plurality of holes 110H may be staggered or arranged in a zigzag fashion along the X-axis direction.

The plurality of second material patterns 120, the plurality of radiation sources 130, the plurality of third material patterns 140, and the plurality of fourth material patterns 150 fill the plurality of holes 110H together, as previously described. Thus, the above description of the arrangement of the plurality of holes 110H may also apply to the plurality of second material patterns 120, the plurality of radiation sources 130, the plurality of third material patterns 140, and the plurality of fourth material patterns 150.

### Tenth Aspect

FIG. 23 is a plan view of an integrated battery 100b according to an aspect.

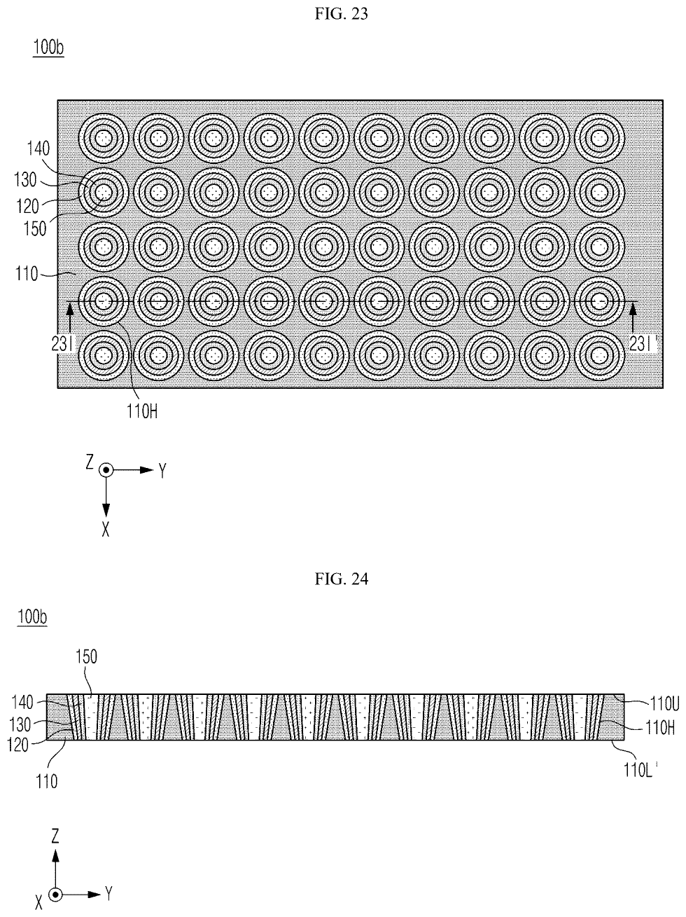

FIG. 24 is a cross-sectional view taken along line 23I-23I′ of FIG. 23.

Referring to FIGS. 23 and 24, the integrated battery 100b may include a substrate 110, a plurality of second material patterns 120, a plurality of radiation sources 130, a plurality of third material patterns 140, and a plurality of fourth material patterns 150. The substrate 110, the plurality of second material patterns 120, the plurality of radiation sources 130, the plurality of third material patterns 140, and the plurality of fourth material patterns 150 are substantially the same as those described above with reference to FIGS. 1 to 16, except for an arrangement of a plurality of holes 110H. Thus, redundant description thereof is omitted here.

In the present aspect, the plurality of holes 110H may be arranged in a matrix, unlike the plurality of holes 110H of FIG. 16 that are arranged in the honeycomb structure. As described herein, a plurality of holes 110H are aligned in a matrix when the plurality of holes 110H are aligned in the X-axis direction and the Y-axis direction. In the present aspect, the plurality of holes 110H may be aligned in the X-axis direction. In the present aspect, the plurality of holes 110H may be aligned in the Y-axis direction.

The plurality of second material patterns 120, the plurality of radiation sources 130, the plurality of third material patterns 140, and the plurality of fourth material patterns 150 fill the plurality of holes 110H together, and thus, the above description of the arrangement of the plurality of holes 110H may also apply to the plurality of second material patterns 120, the plurality of radiation sources 130, the plurality of third material patterns 140, and the plurality of fourth material patterns 150.

### Eleventh Aspect

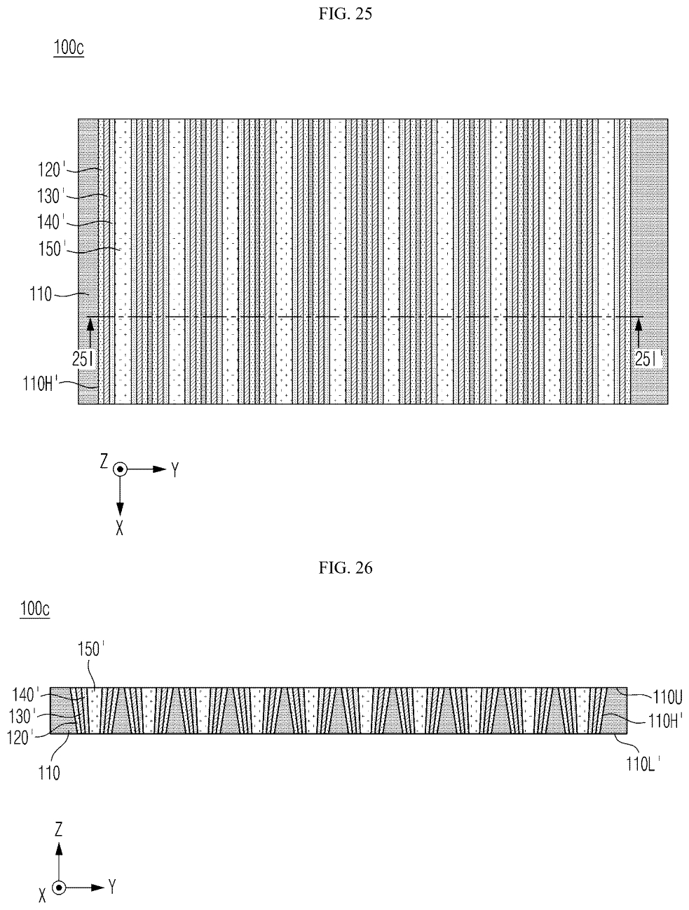

FIG. 25 is a plan view of an integrated battery 100c according to an aspect.

FIG. 26 is a cross-sectional view taken along line 25I-25I′ of FIG. 25.

Referring to FIGS. 25 and 26, the integrated battery 100c may include a substrate 110, a plurality of second material patterns 120′, a plurality of radiation sources 130′, a plurality of third material patterns 140′, and a plurality of fourth material patterns 150′. The substrate 110, the plurality of second material patterns 120′, the plurality of radiation sources 130′, the plurality of third material patterns 140′, and the plurality of fourth material patterns 150′ are substantially the same as those described above with reference to FIGS. 1 to 16, except for a change in a shape of a plurality of holes 110H′. Thus, redundant description thereof is omitted here.

In the present aspect, the plurality of holes 110H′ may have a linear shape, unlike the circular shape of the plurality of holes 110H of FIG. 16. In one or more aspects, holes having a linear shape may be elongated along a direction perpendicular to the Z-axis direction. In one or more aspects, holes having a linear shape may be elongated along the X-axis direction or along the Y-axis direction. For example, each of the plurality of holes 110H′ may be elongated along the X-axis direction, as depicted in FIG. 25. In one or more aspects, the plurality of holes 110H′ may have a line-and-space structure. For example, the plurality of holes 110H′ may be spaced apart from each other in the Y-axis direction.

Each of the plurality of second material patterns 120′ may be on a side wall of a corresponding one of the plurality of holes 110H′. For example, each of the plurality of second material patterns 120′ may extend along the X-axis direction. Each of the plurality of second material patterns 120′ may have a uniform thickness.

The plurality of radiation sources 130′ may be on the plurality of second material patterns 120′. For example, each of the plurality of radiation sources 130′ may extend along the X-axis direction. Each of the plurality of radiation sources 130′ may have a uniform thickness.

The plurality of third material patterns 140′ may be on the plurality of radiation sources 130′. Each of the plurality of third material patterns 140′ may extend along the X-axis direction. Each of the plurality of third material patterns 140′ may have a uniform thickness.

The plurality of fourth material patterns 150′ may be on the plurality of third material patterns 140′. Each of the plurality of fourth material patterns 150′ may be elongated along the X-axis direction. Each of the plurality of fourth material patterns 150′ may have a linear shape extending along the X-axis direction. Each of the plurality of fourth material patterns 150′ may have a tapered shape in the Z-axis direction.

### Twelfth Aspect

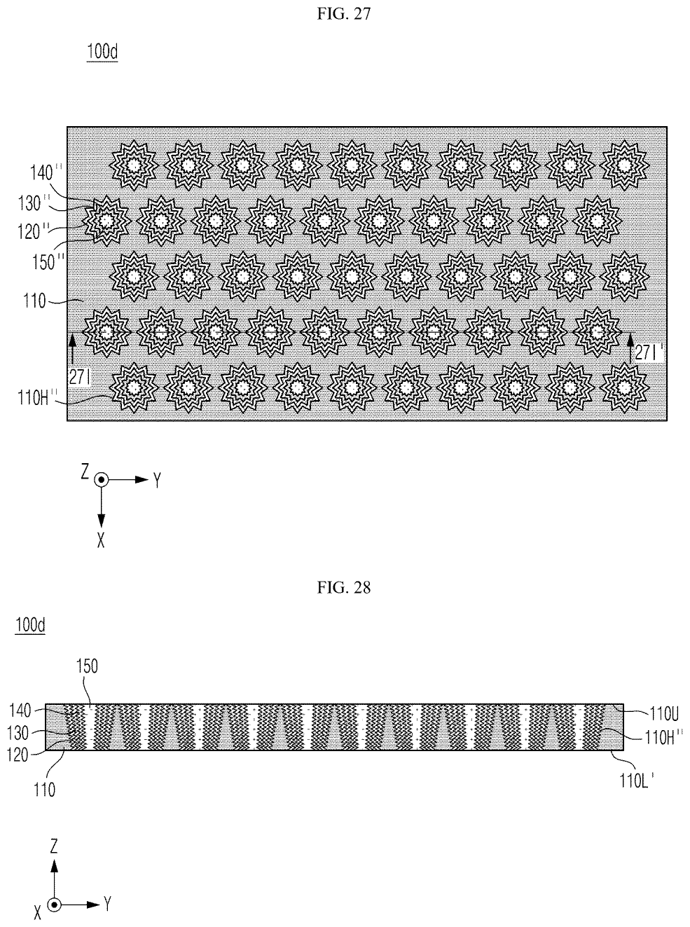

FIG. 27 is a plan view of an integrated battery 100d according to an aspect.

FIG. 28 is a cross-sectional view taken along line 27I-27I′ of FIG. 27.

Referring to FIGS. 27 and 28, the integrated battery 100d may include a substrate 110, a plurality of second material patterns 120″, a plurality of radiation sources 130″, a plurality of third material patterns 140″, and a plurality of fourth material patterns 150″. The substrate 110, the plurality of second material patterns 120″, the plurality of radiation sources 130″, the plurality of third material patterns 140″, and the plurality of fourth material patterns 150″ are substantially the same as those described above with reference to FIGS. 1 to 16, except for a change in a shape of a plurality of holes 110H″. Thus, redundant description thereof is omitted here.

According to aspects, an additional etching process may be performed to roughen the plurality of holes 110H″ before forming a material layer, such as the second material layer 120L as described above with respect to FIG. 7, to form the plurality of second material patterns 120″. The additional etching process may be, for example, a wet etching process.

According to aspects, each of the plurality of holes 110H″ may have a roughened circular shape along their perimeters when viewed from above after the additional etching process. According to one or more aspects, each of the plurality of holes 110H″ may have a star shape when viewed from above after the additional etching process.

According to aspects, each of the second material patterns 120″ may have a roughened ring shape when viewed from above. For example, the second material pattern 120″ may be conformal to the hole 110H″ and may have a substantially similar roughened surface. In one or more aspects, each of the plurality of second material patterns 120″ may have a hollow star shape when viewed from above.

According to aspects, each of the plurality of radiation sources 130″ may have a roughened ring shape along their perimeters when viewed from above. According to aspects, each of the plurality of radiation sources 130″ may have a hollow star shape when viewed from above.

According to aspects, each of the plurality of third material patterns 140″ may have a roughened ring shape along their perimeters when viewed from above. According to aspects, each of the plurality of third material patterns 140″ may have a hollow star shape when viewed from above.

According to aspects, each of the plurality of fourth material patterns 150″ may have a roughened circular shape along their perimeters when viewed from above. According to aspects, each of the plurality of fourth material patterns 150″ may have a star shape when viewed from above.

According to aspects, the roughened shapes of the plurality of holes 110H″, the second material patterns 120″, the plurality of radiation sources 130″, the plurality of third material patterns 140″, and the plurality of fourth material patterns 150″, when viewed from above, may follow tapered profiles along the Z-axis direction. In some aspects, those tapered profiles may be smooth along the Z-axis direction, such that interfaces between the abutting materials define straight lines in a YZ plane, normal to the X-axis direction. In other aspects, as shown in FIG. 28, the tapered profiles may be roughened along the Z-axis direction.

According to aspects, an interface between the substrate 110 and each of the plurality of second material patterns 120″ may be roughened. According to aspects, an interface between each of the plurality of second material patterns 120″ and each of the plurality of radiation sources 130″ may be roughened. According to aspects, an interface between each of the plurality of radiation sources 130″ and each of the plurality of third material patterns 140″ may be roughened. According to aspects, an interface between each of the plurality of third material patterns 140″ and each of the plurality of fourth material patterns 150″ may be roughened. In such aspects, the surface area over which the substrate 110 contacts each of the plurality of second material patterns 120″ may be increased, the surface area over which each of the plurality of the second material patterns 120″ contacts each of the plurality of radiation sources 130″ may be increased, the surface area over which each of the plurality of radiation sources 130″ contacts each of the plurality of third material patterns 140″ may be increased, and the surface are over which each of the plurality of third material patterns 140″ contacts each of the plurality of fourth material patterns 150″ may be increased.

### Thirteenth and Fourteenth Aspects

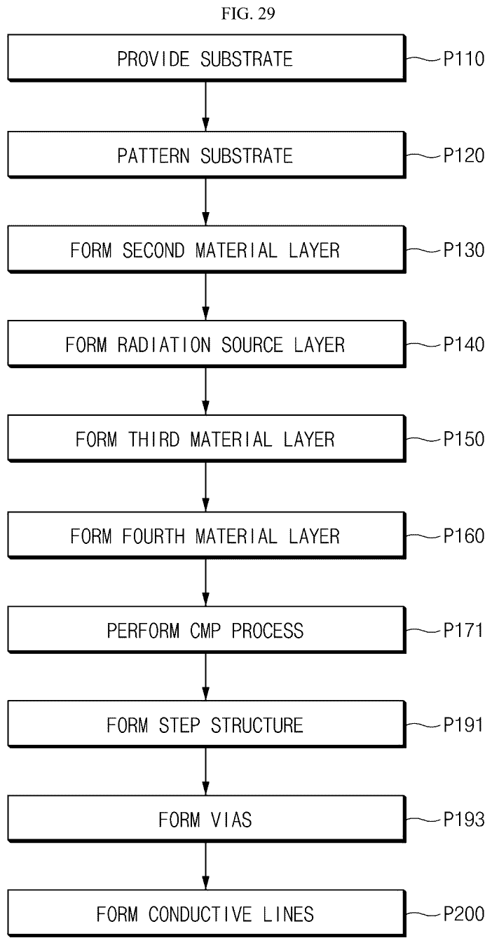

FIG. 29 is a flowchart of a method of manufacturing an integrated battery according to an aspect.

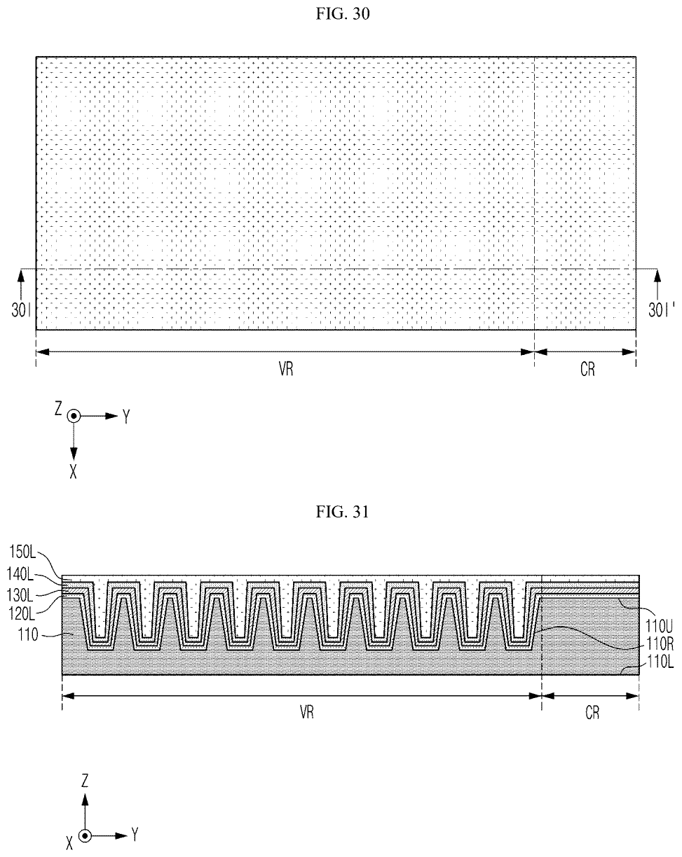

FIG. 30 is a plan view illustrating a step of a method of manufacturing an integrated battery according to an aspect.

FIG. 31 is a cross-sectional view taken along line 30I-30I′ of FIG. 30.

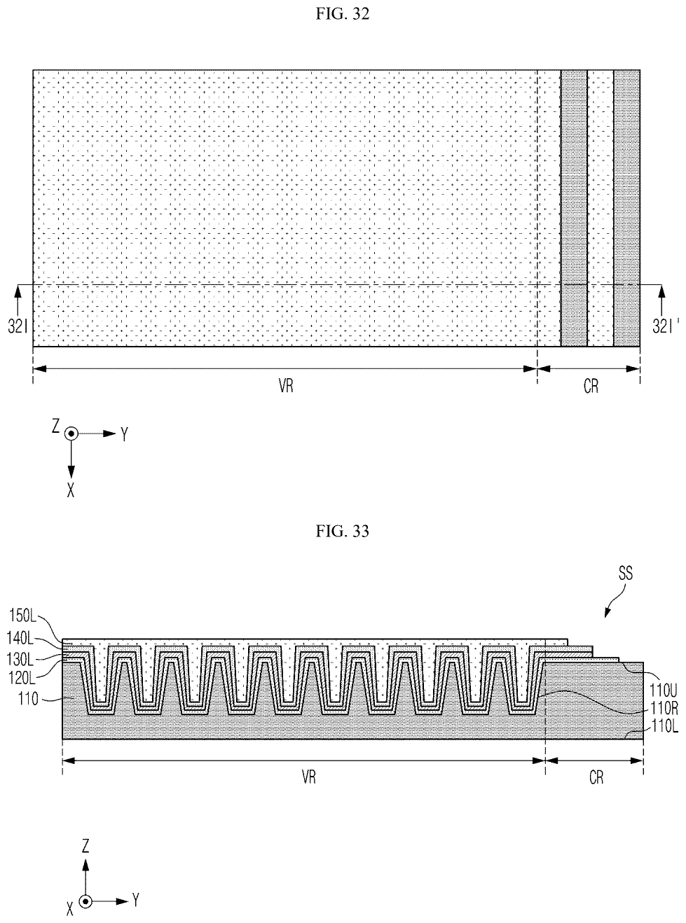

FIG. 32 is a plan view illustrating a step of a method of manufacturing an integrated battery according to an aspect.

FIG. 33 is a cross-sectional view taken along line 32I-32I′ of FIG. 32.

FIG. 34 is a plan view illustrating a step of a method of manufacturing an integrated battery according to an aspect.

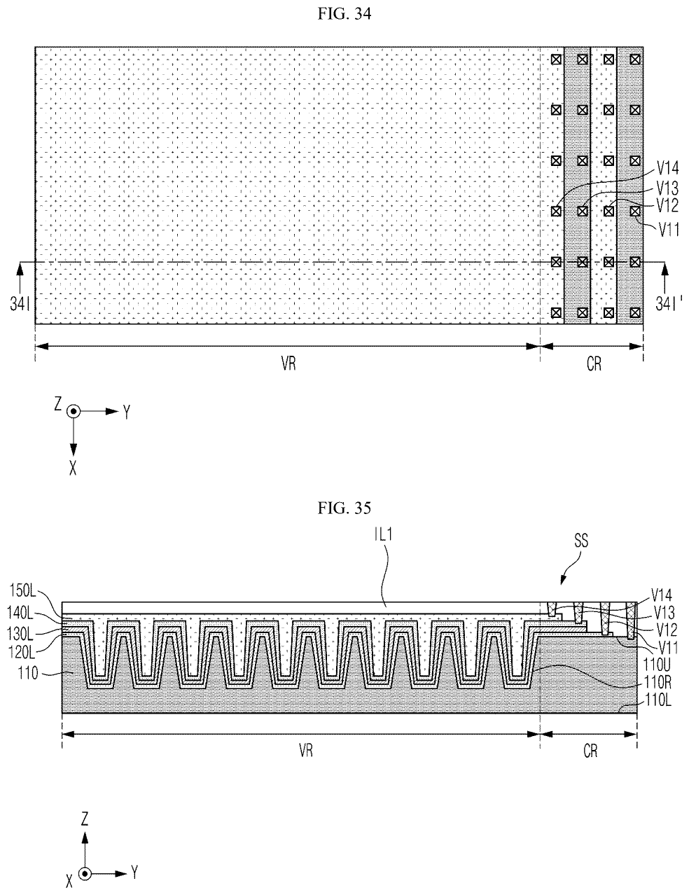

FIG. 35 is a cross-sectional view taken along line 34I-34I′ of FIG. 34.

For convenience of description, a description of parts in FIGS. 29 to 35 that are the same as those described above with reference to FIGS. 1 to 16 is omitted here, and FIGS. 29 to 35 will be described focusing on differences from FIGS. 1 to 16 described above.

Referring now to FIGS. 29 to 31, operations performed in steps P110 to P160 of the method of manufacturing an integrated battery of FIG. 29 are substantially the same as those described above with reference to FIG. 1, except that the substrate 110 may include an electrical region VR and a contact region CR. In the electrical region VR, the substrate 110 may be patterned as shown in FIG. 3 and may include a plurality of recesses 110R. In the contact region CR, the substrate 110 may not be patterned and may not include a plurality of recesses 110R. In such aspects, the contact region CR of the substrate may be free from the plurality of recesses 110R.

Next, in step P171 of the method of manufacturing an integrated battery of FIG. 29, a CMP process may be performed. The CMP process in step P171 may at least partially remove an upper part of a fourth material layer 150L. In one or more aspects, an upper surface of the fourth material layer 150L may be planarized during the CMP process. In the CMP process in step P171, the second material layer 120L, the radiation source layer 130L, the third material layer 140L, and the fourth material layer 150L may not be separated. In some aspects, the CMP process of step P171 may be omitted.

Referring now to FIGS. 29, 32, and 33, in step P191 of the method of manufacturing an integrated battery of FIG. 29, a step structure SS may be formed. The step structure SS may be formed by repeated masking and etching steps. The masking steps may include forming a mask by photolithography. The step structure SS may include the third material layer 140L protruding from the electrical region VR into the contact region CR in a horizontal direction (e.g., the Y-axis direction) a greater distance than the fourth material layer 150L, the second material layer 120L protruding from the electrical region VR into the contact region CR in the horizontal direction (e.g., the Y-axis direction) a greater distance than the third material layer 140L, and the substrate 110 protruding from the electrical region VR into the contact region CR in the horizontal direction (e.g., the Y-axis direction) a greater distance than the second material layer 120L. In such aspects, the fourth material layer 150L is the top step of the step structure SS and the substrate 110 is the bottom step of the step structure SS. In such aspects, an upper surface of the third material layer 140L, an upper surface of the second material layer 120L, and an upper surface 110U of the substrate 110 may be exposed in the contact region CR.

Referring now to FIGS. 29, 34, and 35, in step P193 of the method of manufacturing an integrated battery of FIG. 29, vias V11, V12, V13, and V14 may be formed. Forming the vias V11, V12, V13, and V14 may include depositing an insulating material onto the fourth material layer 150L and the step structure SS to form an insulating material layer and etching the insulating material layer to form an insulating layer ILL. The insulating layer IL1 may include a plurality of via holes exposing the upper surface 110U of the substrate 110, a plurality of via holes exposing the upper surface of the second material layer 120L, a plurality of via holes exposing the upper surface of the third material layer 140L, and a plurality of via holes exposing the upper surface of the fourth material layer 150L. In one or more aspects the plurality of via holes may be in the contact region CR. Forming the vias V11, V12, V13, and V14 may further include filling the via holes with a conductive material layer, and dividing the conductive material layer into the vias V11, V12, V13, and V14 through a planarization process.

Each of the vias V11 may be landed on the substrate 110. In such aspects, each of the vias V11 may be electrically connected to the substrate 110. Each of the vias V11 may be in contact with the substrate 110. Each of the vias V11 may extend in the Z-axis direction. Each of the vias V11 may penetrate the insulating layer IL1. The vias V11 may be spaced apart in the X-axis direction such that a voltage drop of the substrate 110 in the X-axis direction may be prevented.

Each of the vias V12 may be landed on the second material layer 120L. In such aspects, each of the vias V12 may be electrically connected to the second material layer 120L. Each of the vias V12 may be in contact with the second material layer 120L. Each of the vias V12 may extend in the Z-axis direction. Each of the vias V12 may penetrate the insulating layer ILL. The vias V12 may be spaced apart in the X-axis direction such that a voltage drop of the second material layer 120L in the X-axis direction may be prevented.

Each of the vias V13 may be landed on the third material layer 140L. In such aspects, each of the vias V13 may be electrically connected to the third material layer 140L. Each of the vias V13 may be in contact with the third material layer 140L. Each of the vias V13 may extend in the Z-axis direction. Each of the vias V13 may penetrate the insulating layer ILL. The vias V13 may be spaced apart in the X-axis direction such that a voltage drop of the first layer 140L in the X-axis direction may be prevented.

Each of the vias V14 may be landed on the fourth material layer 150L. In such aspects, each of the vias V14 may be electrically connected to the fourth material layer 150L. Each of the vias V14 may be in contact with the fourth material layer 150L. Each of the vias V14 may extend in the Z-axis direction. Each of the vias V14 may penetrate the insulating layer ILL. The vias V14 may be arranged in the X-axis direction such that a voltage drop of the fourth material layer 150L in the X-axis direction may be prevented.

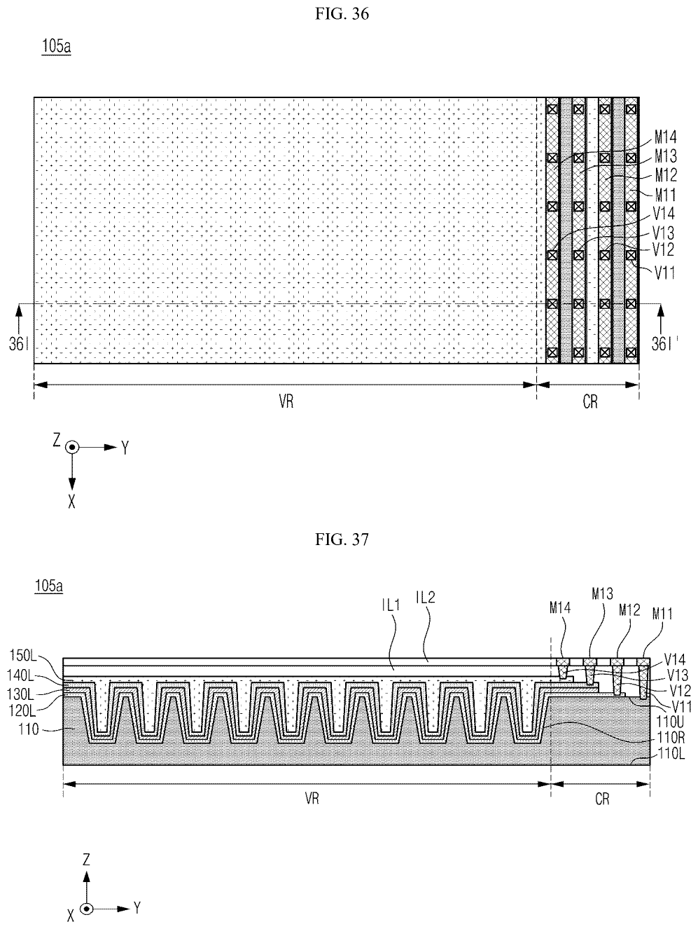

Referring now to FIGS. 29, 36, and 37, in step P200 of the method of manufacturing an integrated battery of FIG. 29, conductive lines M11, M12, M13, and M14 may be formed. By forming the conductive lines M11, M2, M13 and M14, an integrated battery 105a including the substrate 110, the second material layer 120L, the radiation source layer 130L, the third material layer 140L, the fourth material layer 150L, the insulating layers IL1 and IL2, the vias V11, V12, V13, and V14, and the conductive lines M11, M12, M13, and M14 may be produced.

Forming the conductive lines M11, M12, M13, and M14 may include forming a second insulating layer IL2 on the insulating layer IL1, etching at least a portion of the second insulating layer IL2 to expose the vias V11, V12, V13, and V14, depositing a conductive material within an etched portion of the second insulating layer IL2 to contact the vias V11, V12, V13 and V14, and performing a CMP process. In some aspects, unlike in FIGS. 34 to 37, the vias V11, V12, V13, and V14 and the conductive lines M11, M12, M13, and M14 may be formed by a dual damascene process.

In one or more aspects, the conductive line M11 may extend in the X-axis direction. The conductive line M11 may be in contact with each of the vias V11. The conductive line M11 may be electrically connected to each of the vias V11. In one or more aspects, the conductive line M12 may extend in the X-axis direction. The conductive line M12 may be in contact with each of the vias V12. The conductive line M12 may be electrically connected to each of the vias V12. In one or more aspects, the conductive line M13 may extend in the X-axis direction. The conductive line M13 may be in contact with each of the vias V13. The conductive line M13 may be electrically connected to each of the vias V13. In one or more aspects, the conductive line M14 may extend in the X-axis direction. The conductive line M14 may be in contact with each of the vias V14. The conductive line M14 may be electrically connected to each of the vias V14.

Each of the insulating layers IL1 and IL2 may include one or more of silicate (e.g., TEOS), silicon nitride (SiN), hafnium oxide, hafnium silicon oxide, hafnium aluminum oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, or aluminum oxide.

Each of the vias V11, V12, V13, and V14 and the conductive lines M11, M12, M13, and M14 may include one or more of aluminum (Al), copper (Cu), tungsten (W), or titanium (Ti).

According to aspects, the vias V11 and the conductive line M11 may form a first output terminal of a cell including the substrate 110 and the second material layer 120L.

According to aspects, the vias V12 and the conductive line M12 may form a second output terminal of the cell including the substrate 110 and the second material layer 120L.

According to aspects, the vias V13 and the conductive line M13 may form a first output terminal of a cell including the third material layer 140L and the fourth material layer 150L.

According to aspects, the vias V14 and the conductive line M14 may form a second output terminal of the cell including the third material layer 140L and the fourth material layer 150L.

According to aspects, separating the contact region CR from the electrical region VR in the horizontal direction (i.e., the Y-axis direction) may allow a wiring structure connected to the third material layer 140L and the fourth layer 150L, which have a relatively narrow pitch in the electrical region VR, may be easily formed.

### Fifteenth Aspect

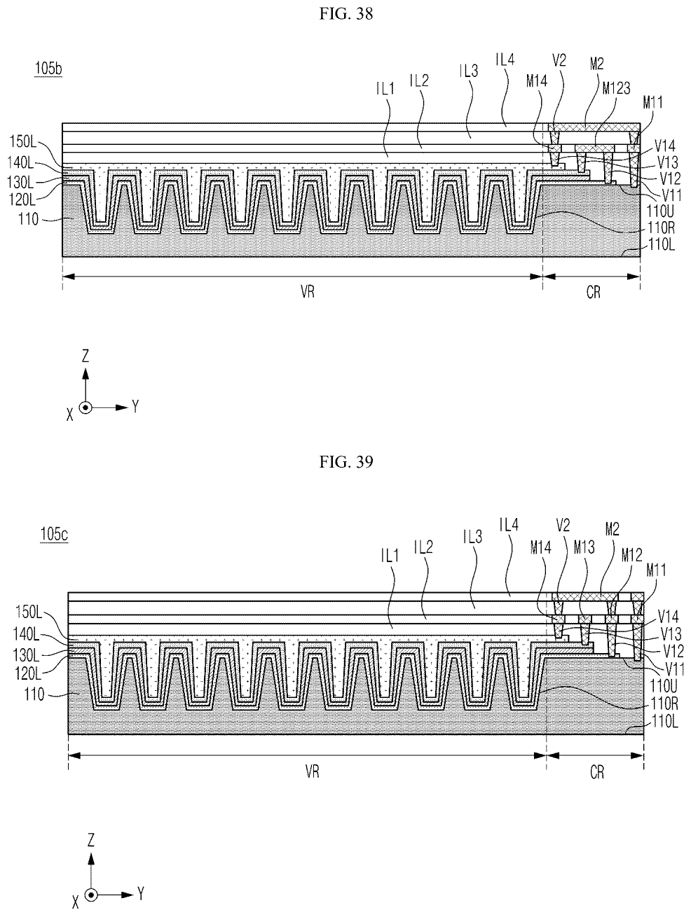

FIG. 38 is a cross-sectional view of an integrated battery 105b according to an aspect.

Referring to FIG. 38, the integrated battery 105b includes a substrate 110, a second material layer 120L, an radiation source layer 130L, a third material layer 140L, a fourth material layer 150L, insulating layers IL1, IL2, IL3 and IL4, vias V11, V12, V13 and V14, conductive lines M11, M123 and M14, vias V2, and a conductive line M2.

The substrate 110, the second material layer 120L, the radiation source layer 130L, the third material layer 140L, the fourth material layer 150L, the insulating layers IL1 and IL2, the vias V11, V12, V13 and V14 and the conductive lines M11 and M14 are substantially the same as those described above with reference to FIGS. 29 to 37. Thus, redundant description thereof is omitted here.

The third insulating layer IL3 may be on the second insulating layer IL2. The fourth insulating layer IL4 may be on the third insulating layer IL3. The insulating layers IL3 and IL4 may include any of the materials described above with respect to the insulating layers IL1 and IL2.

The conductive line M123 may be within the second insulating layer IL2. The conductive line M123 may extend in the X-axis direction. The conductive line M123 may be in contact with each of the vias V12. The conductive line M123 may be in contact with each of the vias V13. Accordingly, the second material layer 120L may be electrically connected to the third material layer 140L through the vias V12, the conductive line M123, and the vias V13.

The vias V2 may penetrate the insulating layer IL3. A first portion of the vias V2 may be landed on the conductive line M11. The first portion of the vias V2 may be in contact with the conductive line M11. A second portion of the vias V2 may be landed on the conductive line M14. The second portion of the vias V2 may be in contact with the conductive line M14. The conductive line M2 may be in contact with the first portion of the vias V2 and the second portion of the vias V2. Each of the conductive lines M2 and the vias V2 may include one or more of aluminum (Al), copper (Cu), tungsten (W), or titanium (Ti).

According to aspects, the substrate 110 may be connected to the fourth material layer 150L through the vias V11, the conductive line M11, the first portion of the vias V2, the conductive line M2, the second portion of the vias V2, the conductive line M14, and the vias V14.

Accordingly, when the fourth material layer 150L and the substrate 110 are of the same conductivity type and the third material layer 140L and the second material layer 120L are of the same conductivity type, a cell including the substrate 110 and the second material layer 120L may be connected in parallel to a cell including the third material layer 140L and the fourth material layer 150L.

### Sixteenth Aspect

FIG. 39 is a cross-sectional view of an integrated battery 105c according to an aspect.

Referring to FIG. 39, the integrated battery 105c includes a substrate 110, a second material layer 120L, a radiation source layer 130L, a third material layer 140L, a fourth material layer 150L, insulating layers IL1, IL2, IL3 and IL4, vias V11, V12, V13 and V14, conductive lines M11, M12, M13 and M14, vias V2, and a conductive lines M2.

The substrate 110, the second material layer 120L, the radiation source layer 130L, the third material layer 140L, the fourth material layer 150L, the insulating layers IL1, IL2, IL3 and IL4, the vias V11, V12, V13 and V14, the conductive lines M11, M12, M13 and M14, the vias V2, and the conductive lines M2 are substantially the same as those described above with reference to FIGS. 29 to 38, except for a connection pattern. Thus, redundant description thereof is omitted here.

A first portion of the vias V2 may be landed on the conductive line M11. The first portion of the vias V2 may be in contact with the conductive line M11. A second portion of the vias V2 may be landed on the conductive line M12. The second portion of the vias V2 may be in contact with the conductive line M12. A third portion of the vias V2 may be landed on the conductive line M14. The third portion of the vias V2 may be in contact with the conductive line M14.

The conductive lines M2 may be within the fourth insulating layer IL4. A first conductive line M2 may be in contact with each of the first portion of the vias V2 on the conductive line M11. A second conductive line M2 may be in contact with each of the second portion of the vias V2 on the conductive line M12. The second conductive line M2 may be in contact with each of the third portion of the vias V2 on the conductive line M14.

According to aspects, the second material layer 120L may be connected to the fourth material layer 150L through the vias V12, the conductive line M12, the second portion of the vias V2, the second conductive line M2, the third portion of the vias V2, the conductive line M14, and the vias V14.

According to aspects, the vias V11, the conductive line M11, the first portion of the vias V2, and the first conductive line M2 connected to the substrate 110 may form a first output terminal of the integrated battery 105c. According to aspects, the vias V13 and the conductive line M13 connected to the third material layer 140L may form a second output terminal of the integrated battery 105c.

According to aspects, when the fourth material layer 150L and the substrate 110 have a p type conductivity type and the third material layer 140L and the second material layer 120L have a n type conductivity type, a cell including the substrate 110 and the second material layer 120L may be connected in series to a cell including the third material layer 140L and the fourth material layer 150L.

### Seventeenth Aspect

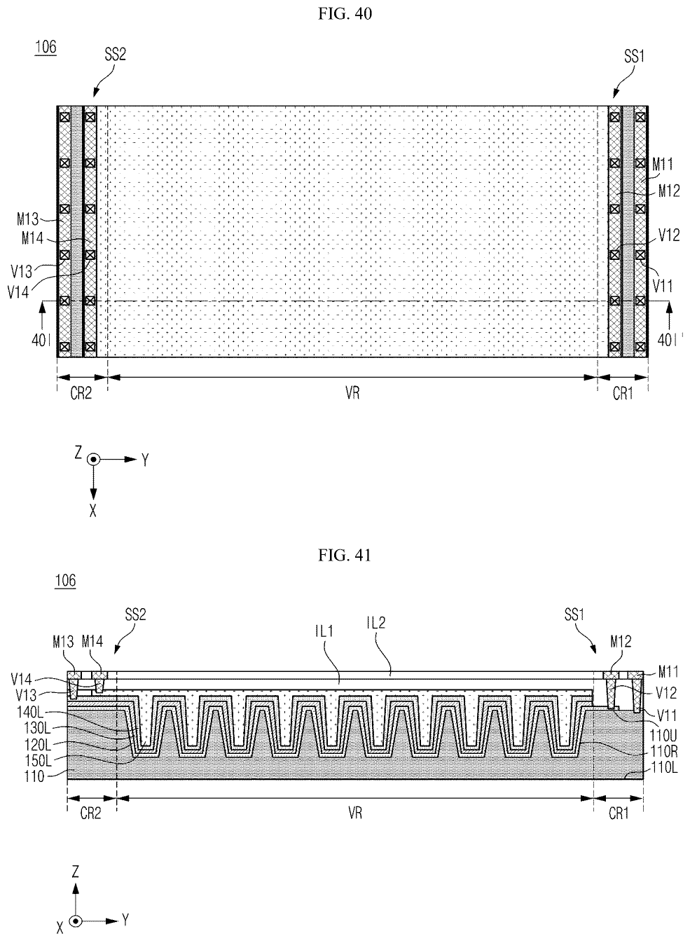

FIG. 40 is a plan view of an integrated battery according to aspects.

FIG. 41 is a cross-sectional view taken along line 40I-40I′ of FIG. 40.

Referring now to FIGS. 40 and 41, an integrated battery 106 may include a substrate 110, a second material layer 120L, a radiation source layer 130L, a third material layer 140L, a fourth material layer 150L, insulating layers IL1 and IL2, vias V11, V12, V13 and V14 and conductive lines M11, M12, M13 and M14.

The substrate 110 may include an electrical region VR, a first contact region CR1, and a second contact region CR2. In the electrical region VR, the substrate 110 may be patterned as shown in FIG. 3 and may include a plurality of recesses 110R.

In the first contact region CR1 and the second contact region CR2, the substrate 110 may not be patterned and may not include a plurality of recesses 110R. In such aspects, the first contact region CR1 and the second contact region CR2 may be free from the plurality of recesses 110R. The electrical region VR may be interposed between the first contact region CR1 and the second contact region CR2. The first contact region CR1 and the second contact region CR2 may be spaced apart from each other in the Y-axis direction.

The first contact region CR1 may comprise a first step structure SS1. The first step structure SS1 may include the second material layer 120L protruding from the electrical region VR into the first contact region CR1 in a horizontal direction (e.g., the Y-axis direction) a greater distance that the third material layer 140L and the fourth material layer 150L. The first step structure SS1 may include the substrate 110 protruding from the electrical region VR into the first contact region CR1 in the horizontal direction (e.g., the Y-axis direction) a greater distance than the second material layer 120L. In such aspects, the second material layer 120L may be the top step and the substrate 110 may be the bottom step of the first step structure SS1.

The second contact region CR2 may comprise a second step structure SS2. The second step structure SS2 may include the third material layer 140L protruding from the electrical region VR into the second contact region CR2 in the horizontal direction (e.g., the Y-axis direction) a greater distance than the fourth material layer 150L. In such aspects, the fourth material layer 150L may be the top step and the third material layer 140L may be the bottom step of the second step structure SS2.

According to aspects, the vias V11 and V12 and the conductive lines M11 and M12 may be in the first contact region CR1, and the vias V13 and V14 and the conductive lines M13 and M14 may be in the second contact region CR2. Accordingly, interference between wires can be prevented, and freedom in the wiring design can be improved.

### Eighteenth Aspect

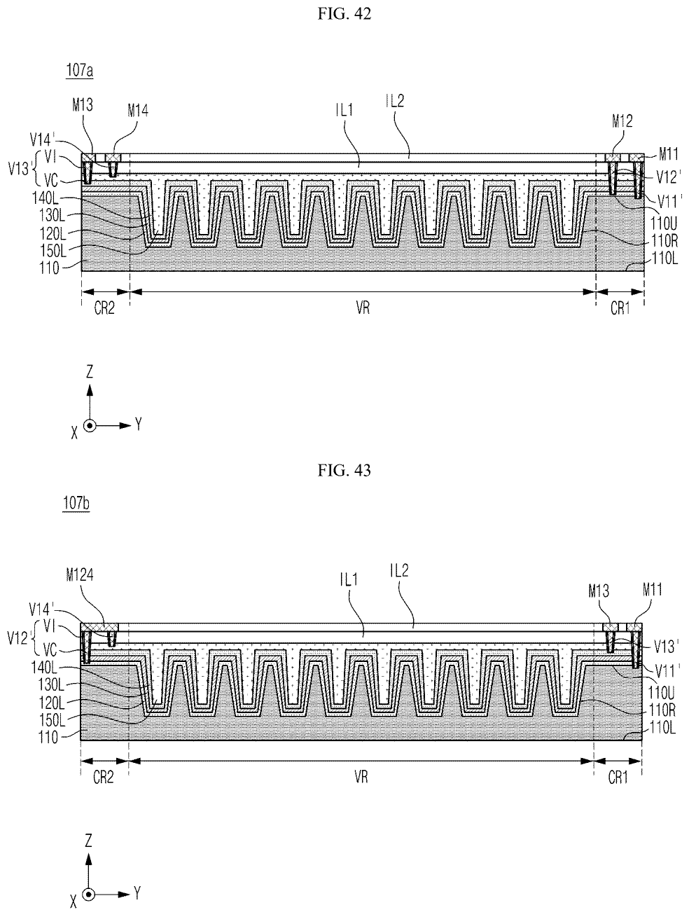

FIG. 42 is a cross-sectional view of an integrated battery 107a according to an aspect.

Referring to FIG. 42, the integrated battery 107a may include a substrate 110, a second material layer 120L, a radiation source layer 130L, a third material layer 140L, a fourth material layer 150L, insulating layers IL1 and IL2, vias V11′, V12′, V13′ and V14′ and conductive lines M11, M12, M13 and M14.

The integrated battery 107a is substantially the same as the integrated battery 106 of FIG. 41, except that the integrated battery 107a includes the vias V11′, V12′, V13′ and V14′ instead of the vias V11, V12, V13, and V14.

Each of the vias V11′, V12′, V13′ and V14′ may include a passivation layer VI and a conductive layer VC. The passivation layer VI may include an insulating material. The conductive layer VC may include a conductive material. The conductive layer VC may be at least partially surrounded by the passivation layer VI.

The passivation layer VI may be on an inner wall of a via hole. The passivation layer VI may be configured to prevent an undesired short circuit between the conductive layer VC of each of the vias V11′, V12′, V13′ and V14′. In one or more aspects, the passivation layer VI of each of the vias V11′ may prevent a short circuit between the conductive layer VC and the second material layer 120L, the radiation source layer 130L, the third material layer 140L and the fourth material layer 150L.

The conductive layer VC of each of the vias V11′ may be spaced apart from the second material layer 120L, the radiation source layer 130L, the third material layer 140L, and the fourth material layer 150L with the passivation layer VI interposed therebetween. The conductive layer VC of each of the vias V11′ may be in contact with the substrate 110. The vias V11′ may be electrically connected to the substrate 110 on which they are landed.

The passivation layer VI of each of the vias V12′ may prevent a short circuit between the conductive layer VC and the radiation source layer 130L, the third material layer 140L and the fourth material layer 150L.

The conductive layer VC of each of the vias V12′ may be spaced apart from the radiation source layer 130L, the third material layer 140L and the fourth material layer 150L with the passivation layer VI interposed therebetween. The conductive layer VC of each of the vias V12′ may be in contact with the second material layer 120L. The vias V12′ may be electrically connected to the layer 120L on which they are landed.

The passivation layer VI of each of the vias V13′ may prevent a short circuit between the conductive layer VC and the fourth material layer 150L. The conductive layer VC of each of the vias V13′ may be spaced apart from the fourth material layer 150L with the passivation layer VI interposed therebetween. The conductive layer VC of each of the vias V12′ may be in contact with the first layer 140L. The vias V12′ may be electrically connected to the first layer 140L on which they are landed.

The conductive line M11 may be in contact with the conductive layer VC of each of the vias V11′. The conductive line M12 may be in contact with the conductive layer VC of each of the vias V12′. The conductive line M13 may be in contact with the conductive layer VC of each of the vias V13′. The conductive line M14 may be in contact with the conductive layer VC of each of the vias V14′.

According to aspects, each of the vias V11′, V12′, V13′ and V14′ includes the passivation layer VI. In such aspects, and the previously described processes of forming a step structure may be omitted. This may increase throughput of the process of manufacturing the integrated battery 107a and reduce manufacturing costs.

### Nineteenth Aspect

FIG. 43 is a cross-sectional view of an integrated battery 107b according to an aspect.

Referring to FIG. 43, the integrated battery 107b may include a substrate 110, a second material layer 120L, a radiation source layer 130L, a third material layer 140L, a fourth material layer 150L, insulating layers IL1 and IL2, vias V11′, V12′, V13′ and V14′ and conductive lines M11, M124 and M13.

The integrated battery 107b is substantially the same as the integrated battery 107a of FIG. 42, except for a connection and arrangement of the vias V11′, V12′, V13′ and V14′ and the conductive lines M11, M124 and M13.

In the present aspect, the vias V11′ and V13′ may be in the contact region CR1, and the vias V12′ and V14′ may be in the contact region CR2. There may be an electrical region VR between the vias V11′ and V13′ and the vias V12′ and V14′.

The conductive line M11 may be a first output terminal of the integrated battery 107b. The conductive line M13 may be a second output terminal of the integrated battery 107b.

The conductive line M124 may extend in the X-axis direction in the second insulating layer IL2. The conductive line M124 may be in contact with a conductive layer VC of each of the vias V12′. The conductive line M124 may be in contact with a conductive layer VC of each of the vias V14′. The second material layer 120L may be connected to the fourth material layer 150L through the vias V12′, the conductive line M124, and the vias V14′.

According to aspects, when the fourth material layer 150L and the substrate 110 have a p type conductivity type and the third material layer 140L and the second material layer 120L have an n type conductivity type, a cell including the substrate 110 and the second material layer 120L may be connected in series to a cell including the third material layer 140L and the fourth material layer 150L.

According to aspects, the first contact region CR1 and the second contact region CR2 may be separated to implement the series connection described above using a single via layer and a single wiring layer. This may increase a degree of integration of the integrated battery 107b. In addition, the vias V11′, V12′, V13′ and V14′ each including a passivation layer CI are configured to increase the throughput of the process of manufacturing the integrated battery 107b and reduce manufacturing costs.

### Twentieth Aspect

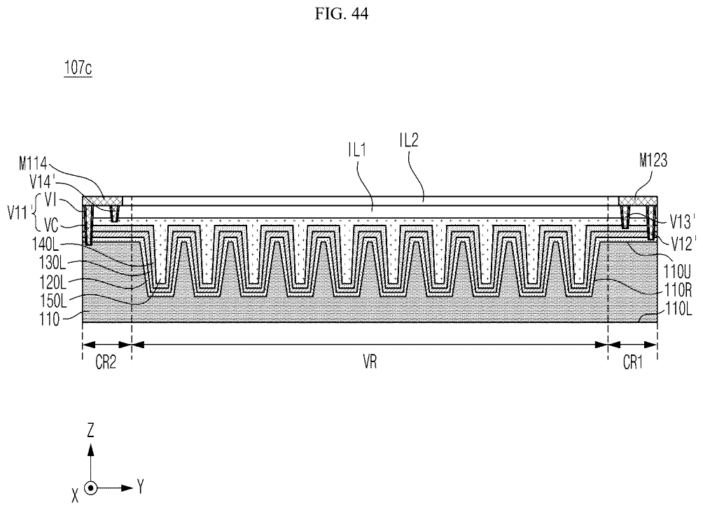

FIG. 44 is a cross-sectional view of an integrated battery 107c according to an aspect.

Referring to FIG. 44, the integrated battery 107c may include a substrate 110, a second material layer 120L, a radiation source layer 130L, a third material layer 140L, a fourth material layer 150L, insulating layers IL1 and IL2, vias V11′, V12′, V13′ and V14′ and conductive lines M114 and M123.

The integrated battery 107c is substantially the same as the integrated battery 107a of FIG. 43, except for a connection and arrangement of the vias V11′, V12′, V13′ and V14′ and the conductive lines M114 and M123.

In the present aspect, the vias V12′ and V13′ may be in a first contact region CR1, and the vias V11′ and V14′ may be in a second contact region CR2. There may be an electrical region VR between the vias V12′ and V13′ and the vias V11′ and V14′.

The conductive line M114 may extend in the X-axis direction in the second insulating layer IL2. The conductive line M114 may be in contact with a conductive layer VC of each of the vias V11′. The conductive line M114 may be in contact with a conductive layer VC of each of the vias V14′. The substrate 110 may be connected to the second layer 150L through the vias V11′, the conductive line M114, and the vias V14′.

The conductive line M123 may extend in the X-axis direction in the second insulating layer IL2. The conductive line M123 may be in contact with a conductive layer VC of each of the vias V12′. The conductive line M123 may be in contact with a conductive layer VC of each of the vias V13′. The second material layer 120L may be connected to the third material layer 140L through the vias V12′, the conductive line M123, and the vias V13′.

According to aspects, when the fourth material layer 150L and the substrate 110 have a p type conductivity type and the third material layer 140L and the second material layer 120L have an n type conductivity type, a cell including the substrate 110 and the second material layer 120L may be connected in parallel to a cell including the third material layer 140L and the fourth material layer 150L.

According to aspects, the first contact region CR1 and the second contact region CR2 may be separated to implement a parallel connection through a single via layer and a single wiring layer. This may increase a degree of integration of the integrated battery 107c. In addition, the vias V11′, V12′, V13′ and V14′ each including a passivation layer CI are configured to increase the throughput of the process of manufacturing the integrated battery 107c and reduce manufacturing costs.

### Twenty-First Aspect

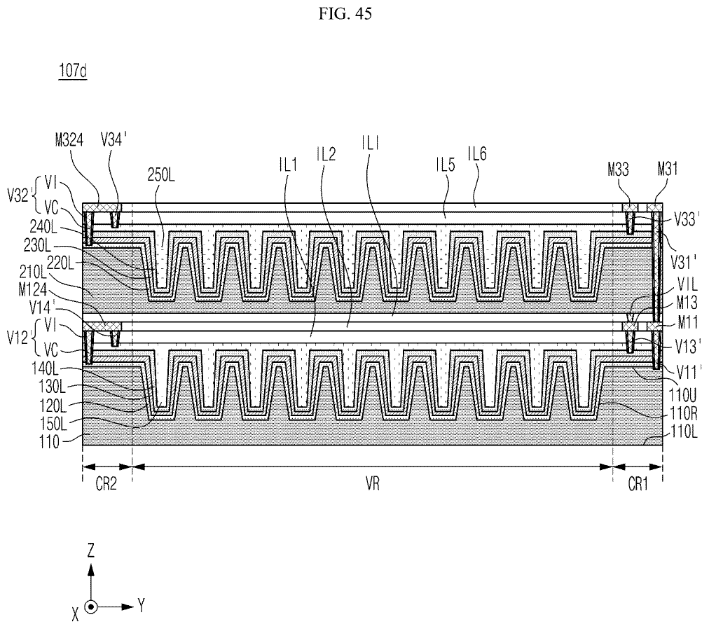

FIG. 45 is a cross-sectional view of an integrated battery 107d according to an aspect.

Referring to FIG. 45, the integrated battery 107d may include a substrate 110, a second material layer 120L, a radiation source layer 130L, a third material layer 140L, a fourth material layer 150L, insulating layers IL1 and IL2, vias V11′, V12′, V13′ and V14′, conductive lines M11, M124 and M13, an intermediate insulating layer ILI, intermediate vias VIL, a fifth material layer 210L, a sixth material layer 220L, second radiation source layer 230L, a seventh material layer 240L, an eighth material layer 250L, insulating layers IL5 and IL6, vias V31′, V32′, V33′ and V34′, and conductive lines M31, M324 and M33.

The substrate 110, the second material layer 120L, the radiation source layer 130L, the third material layer 140L, the fourth material layer 150L, the insulating layers IL1 and IL2, the vias V11′, V12′, V13′ and V14′, and the conductive lines M11, M124 and M13 are substantially the same as those described above with respect to the integrated battery 107b of FIG. 43. Thus, redundant description thereof is omitted here.

A structure and shape of the fifth material layer 210L are substantially the same as a structure and shape of the substrate 110. The fifth material layer 210L may include one or more of the materials described above with respect to the fourth material layer 150L.

A structure and shape of the sixth material layer 220L are substantially the same as a structure and shape of the second material layer 120L. The sixth material layer 220L may include one or more of the materials described above with respect to the third material layer 140L.

A structure, shape, and composition of the second radiation source layer 230L are substantially the same as a structure, shape and composition of the radiation source layer 130L. A structure, shape, and composition of the seventh material layer 240L are substantially the same as a structure, shape and composition of the third material layer 140L. A structure, shape, and composition of the eighth material layer 250L are substantially the same as a structure, shape and composition of the fourth material layer 150L.

The intermediate insulating layer ILI may be between the fifth material layer 210L and the second insulating layer IL2. The intermediate insulating layer ILI may include any of the materials described above with respect to the insulating layers IL1 and IL2.

The intermediate vias VIL may penetrate the intermediate insulating layer ILI. Each of the intermediate vias VIL may be landed on the conductive line M13. Each of the intermediate vias VIL may be in contact with the conductive line M13. Each of the intermediate vias VIL may be in contact with the fifth material layer 210L. A cell including the fifth material layer 210L and the sixth material layer 220L may be connected in series with a cell including the third material layer 140L and the fourth material layer 150L by the intermediate vias VIL.

A structure, shape, and composition of each of the fifth insulating layer IL5 and the sixth insulating layer IL6 are substantially the same as a structure, shape and composition of each of the insulating layer IL1 and the second insulating layer IL2.

Each of the vias V31′, V32′, V33′ and V34′ may include a passivation layer VI and a conductive layer VC. The vias V31′ and V33′ may be in a first contact region CR1, and the vias V32′ and V34′ may be in a second contact region CR2. There may be an electrical region VR between the vias V31′ and V33′ and the vias V32′ and V34′.

Each of the vias V31′ may penetrate the intermediate insulating layer ILI, the fifth material layer 210L, the sixth material layer 220L, the second radiation source layer 230L, the seventh material layer 240L, the eighth material layer 250L, and the fifth insulating layer IL5. The conductive layer VC of each of the vias V31′ may be spaced apart from the fifth material layer 210L, the sixth material layer 220L, the second radiation source layer 230L, the seventh material layer 240L, and the eighth material layer 250L with the passivation layer VI interposed therebetween.

Each of the vias V31′ may be landed on the conductive line M11. The conductive layer VC of each of the vias V31′ may be in contact with the conductive line M11. The vias V31′ may be electrically connected to the conductive line M11 on which they are landed.

The conductive line M31 may extend in the X-axis direction in the sixth insulating layer IL6. The conductive line M31 may be in contact with the conductive layer VC of each of the vias V31′. The conductive line M31 may be a first output terminal of the integrated battery 107d.

Each of the vias V32′ may penetrate the second radiation source layer 230L, the seventh material layer 240L, the eighth material layer 250L, and the fifth insulating layer IL5. The conductive layer VC of each of the vias V32′ may be spaced apart from the second radiation source layer 230L, the seventh material layer 240L, and the eighth material layer 250L with the passivation layer VI interposed therebetween.

Each of the vias V32′ may be landed on the sixth material layer 220L. The conductive layer VC of each of the vias V32′ may be in contact with the sixth material layer 220L. The conductive layer VC of each of the vias V32′ may be electrically connected to the sixth material layer 220L.

Each of the vias V33′ may penetrate the eighth material layer 250L and the fifth insulating layer IL5. The conductive layer VC of each of the vias V32′ may be spaced apart from the eighth material layer 250L with the passivation layer VI interposed therebetween.

Each of the vias V33′ may be landed on the seventh material layer 240L. The conductive layer VC of each of the vias V33′ may be in contact with the seventh material layer 240L. The conductive layer VC of each of the vias V33′ may be electrically connected to the seventh material layer 240L.

The conductive line M33 may extend in the X-axis direction in the sixth insulating layer IL6. The conductive line M33 may be in contact with the conductive layer VC of each of the vias V33′. The conductive line M33 may be a second output terminal of the integrated battery 107d.

Each of the vias V34′ may penetrate the fifth insulating layer IL5. Each of the vias V34′ may be landed on the eighth material layer 250L. The conductive layer VC of each of the vias V34′ may be in contact with the eighth material layer 250L. The conductive layer VC of each of the vias V34′ may be electrically connected to the eighth material layer 250L.

The conductive line M324 may extend in the X-axis direction in the sixth insulating layer IL6. The conductive line M324 may be in contact with the conductive layer VC of each of the vias V32′. The conductive line M324 may be in contact with the conductive layer VC of each of the vias V34′. The sixth material layer 220L may be connected to the eighth material layer 250L through the vias V12′, the conductive line M124, and the vias V14′.

According to aspects, when the fifth material layer 210L and the eighth material layer 250L have a p type conductivity type and the sixth material layer 220L and the seventh material layer 240L have an n type conductivity type, a cell including the fifth material layer 210L and the sixth material layer 220L may be connected in series to a cell including the seventh material layer 240L and the eighth material layer 250L. The integrated battery 107d according to aspects includes a structure in which four pn junctions are connected in series and thus may have a high degree of integration and a high output. It should be understood that in one or more aspects of the present disclosure more than four pn junctions may be connected in series using a configuration similar to that depicted in FIG. 45 with the addition of more layers of pn junctions and radiation sources.

### Twenty-Second and Twenty-Third Aspects

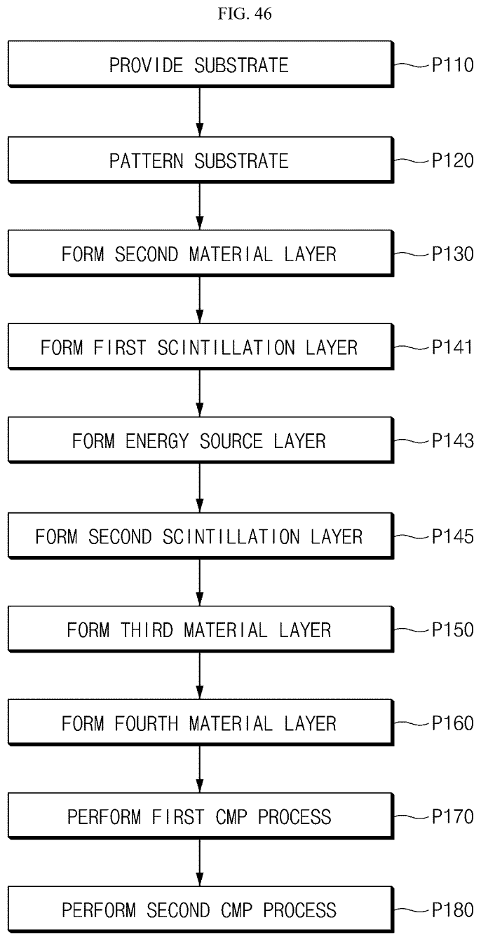

FIG. 46 is a flowchart of a method of manufacturing an integrated battery according to an aspect.

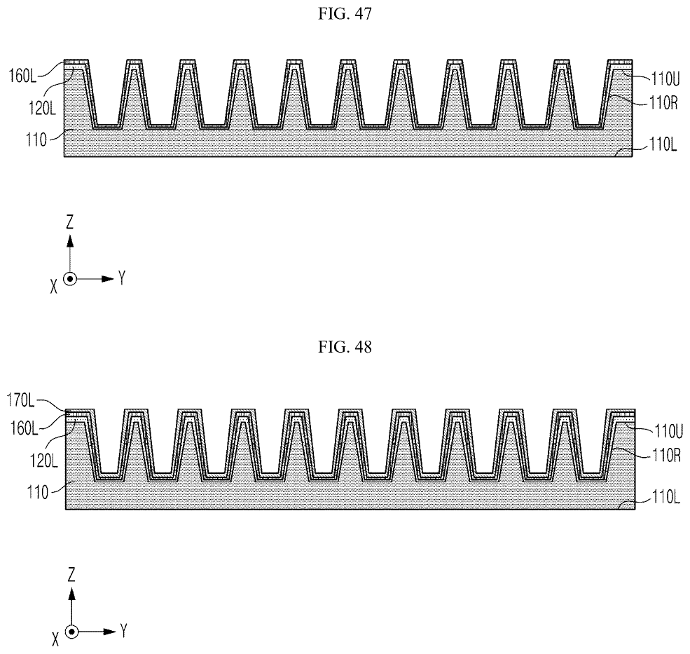

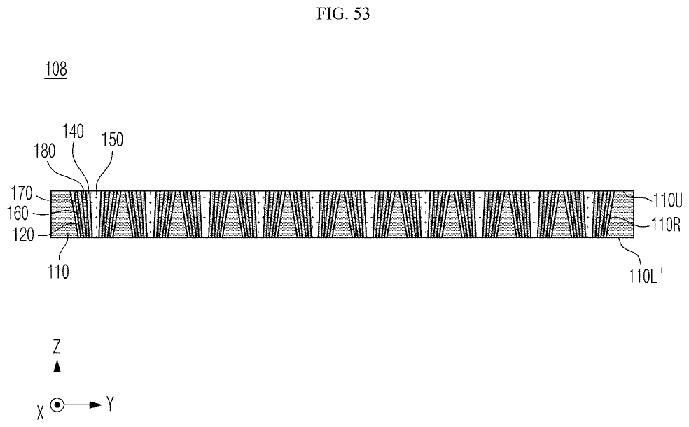

FIGS. 47 to 53 are cross-sectional views illustrating sequential steps of a method of manufacturing an integrated battery according to an aspect.

Referring to FIGS. 46 and 47, the step of providing a substrate 110 in step P110 of the method of manufacturing an integrated battery illustrated in FIG. 46, the steps of patterning the substrate 110 in step P120 of the method of manufacturing an integrated battery illustrated in FIG. 46, and the step of forming a second material layer 120L in step P130 of the method of manufacturing an integrated battery illustrated in FIG. 46 are substantially the same as the corresponding step P110, step P120, and step P130 of the method of manufacturing an integrated battery illustrated in FIG. 1 described above.

In the present aspect, in step P141, a first scintillation layer 160L may be formed. The first scintillation layer 160L may be formed by a deposition process such as CVD. The first scintillation layer 160L may have a uniform thickness. The first scintillation layer 160L may have a conformal shape. The first scintillation layer 160L may comprise a material that emits photons in response to high-energy radiation such as alpha rays. The first scintillation layer 160L may include at least one of Ba₂Ca(BO₃)₂, BaHfO₃, BaI₂:Ce, BeO, BaF₂, BaMgF₄, Cs₂LiLuCi₆:Ce, K₂YF₅, KCaF₃ or YI₃:Ce but is not limited thereto. Various examples of the first scintillation layer 160L are disclosed in the Berkeley Lab Inorganic Scintillator Laboratory found at: https://scintillator.lbl.gov/inorganic-scintillator-library/.

Referring now to FIGS. 46 and 48, in step P143 of the method of making an integrated battery illustrated in FIG. 46, a radiation source layer 170L may be formed. The radiation source layer 170L may have a uniform thickness. The radiation source layer 170L may have a conformal shape. The radiation source layer 170L may be formed by evaporation, sputtering, CVD, electroplating, or electroless plating. When the radiation source layer 170L is formed by electroplating or electroless plating, a seed layer may be formed between the radiation source layer 170L and the first scintillation layer 160L.

The radiation source layer 170L may comprise a radioactive isotope that emits only alpha rays or may include a radioactive isotope that emits both alpha rays and radiation other than alpha rays, such as beta rays or gamma rays. The radiation source layer 170L may include at least one of neodymium-144 (¹⁴⁴Nd), samarium-147 (¹⁴⁷Sm), terbium-158 (¹⁵⁸Tb), tellurium-104 (¹⁰⁴Te), bismuth-212 (²¹²Bi), astatine-210 (²¹⁰At), astatine-211 (²¹¹At), radon-222 (²²²Rn), francium-223 (²²³Fr), radium-224 (²²⁴Ra), radium-226 (²²⁶Ra), actinium-225 (²²⁵Ac), actinium-227 (²²⁷Ac), thorium-228 (²²⁸Th), thorium-230 (²³⁰Th), thorium-232 (²³²Th), protactinium-231 (²³¹Pa), uranium-234 (²³⁴U), uranium-235 (²³⁵U), uranium-238 (²³⁸U), neptunium-237 (²³⁷Np), plutonium-238 (²³⁸Pu), plutonium-239 (²³⁹Pu), plutonium-240 (²⁴⁰Pu), plutonium-241 (²⁴¹Pu), americium-241 (²⁴¹Am), americium-243 (²⁴³Am), curium-242 (²⁴²Cm), curium-243 (²⁴³Cm), curium-244 (²⁴⁴Cm), curium-245 (²⁴⁵Cm), berkelium-247 (²⁴⁷Bk), berkelium-249 (²⁴⁹Bk), californium-249 (²⁴⁹Cf), californium-250 (²⁵⁰Cf), californium-251 (²⁵¹Cf), californium-252 (²⁵²Cf), einsteinium-252 (²⁵²Es), einsteinium-253 (²⁵³Es), fermium-257 (²⁵⁷Fm), mandellevium-258 (²⁵⁸Md), nobelium-255 (²⁵⁵No), laurencium-260 (²⁶⁰Lr), polonium-208 (²⁰⁸Po), polonium-210 (²¹⁰Po), or polonium-212 (²¹²Po).

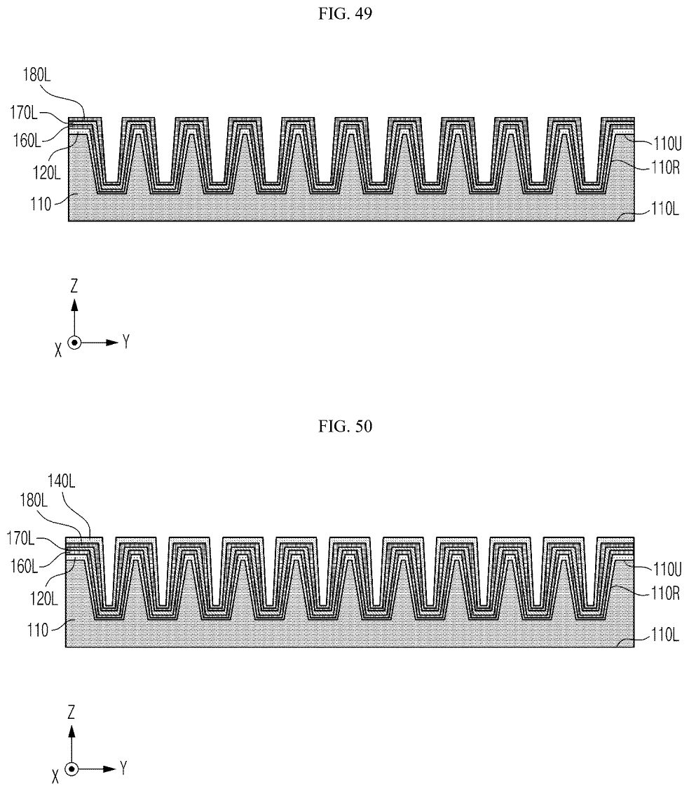

Referring now to FIGS. 46 and 49, in step P145 of the method of making an integrated battery illustrated in FIG. 46, a second scintillation layer 180L may be formed. The second scintillation layer 180L may be formed by a deposition process such as CVD. The second scintillation layer 180L may have a uniform thickness. The second scintillation layer 180L may have a conformal shape. The second scintillation layer 180L may comprise a material that emits photons in response to high-energy radiation. The second scintillation layer 180L may include any of the materials described above with respect to the first scintillation layer 160L.

Referring now to FIGS. 46 and 50, in step P150 of the method of making an integrated battery illustrated in FIG. 46, a third material layer 140L may be formed. The formation of the third material layer 140L is as described above with reference to FIGS. 1, 10 and 11.

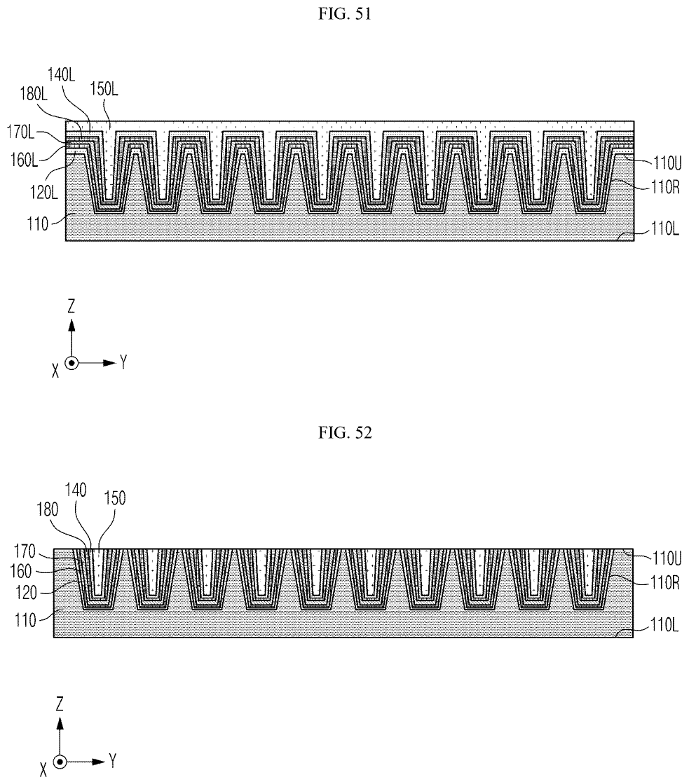

Referring now to FIGS. 46 and 51, in step P160 of the method of making an integrated battery illustrated in FIG. 46, a fourth material layer 150L may be formed. The formation of the fourth material layer 150L is as described above with reference to FIGS. 1, 12 and 13.

Referring now to FIGS. 46, 51, and 52, in step P170 of the method of making an integrated battery illustrated in FIG. 46, a first CMP process may be performed. By the first CMP process, the second material layer 120L may be divided into a plurality of second material patterns 120. By the first CMP process, the first scintillation layer 160L may be divided into a plurality of first scintillation patterns 160. By the first CMP process, the radiation source layer 170L may be divided into a plurality of radiation sources 170. By the first CMP process, the second scintillation layer 180L may be divided into a plurality of second scintillation patterns 180. By the first CMP process, the third material layer 140L may be divided into a plurality of third material patterns 140. By the first CMP process, the fourth material layer 150L may be divided into a plurality of fourth material patterns 150.

An upper surface of each of the plurality of second material patterns 120, an upper surface of each of the plurality of first scintillation patterns 160, an upper surface of each of the plurality of radiation sources 170, an upper surface of each of the plurality of second scintillation patterns 180, an upper surface of each of the plurality of third material patterns 140, and an upper surface of each of the plurality of fourth material patterns 150 may be coplanar with an upper surface 110U of the substrate 110.

Referring to FIGS. 46, 52 and 53, in step P180 of the method of making an integrated battery illustrated in FIG. 46, a second CMP process may be performed. The plurality of fourth material patterns 150 may be an end point of the second CMP process. An integrated battery 108 including the substrate 110, the plurality of second material patterns 120, the plurality of first scintillation patterns 160, the plurality of radiation sources 170, the plurality of second scintillation patterns 180, the plurality of third material patterns 140, and the plurality of fourth material patterns 150 may be formed by the second CMP process.

A plurality of recesses 110R may become a plurality of holes 110H extending to a new lower surface 110L′ of the substrate 110. Each of the plurality of holes 110H may penetrate the substrate 110. A lower surface of each of the plurality of second material patterns 120, a lower surface of each of the plurality of first scintillation patterns 160, a lower surface of each of the plurality of radiation sources 170, a lower surface of each of the plurality of second scintillation patterns 180, a lower surface of each of the plurality of third material patterns 140, and a lower surface of each of the plurality of fourth material patterns 150 may be coplanar with the lower surface 110L′ of the substrate 110.

Each of the plurality of first scintillation patterns 160 may be in a corresponding one of the plurality of holes 110H. Each of the plurality of first scintillation patterns 160 may be between a corresponding one of the plurality of second material patterns 120 and a corresponding one of the plurality of radiation sources 170. Each of the plurality of first scintillation patterns 160 may have a uniform thickness. Each of the plurality of first scintillation patterns 160 may be at least partially surrounded by a corresponding one of the plurality of second material patterns 120.

Each of the plurality of radiation sources 170 may be in a corresponding one of the plurality of holes 110H. Each of the plurality of radiation sources 170 may be between a corresponding one of the plurality of first scintillation patterns 160 and a corresponding one of the plurality of second scintillation patterns 180. Each of the plurality of radiation sources 170 may have a uniform thickness. Each of the plurality of radiation sources 170 may be at least partially surrounded by a corresponding one of the plurality of first scintillation patterns 160.

Each of the plurality of second scintillation patterns 180 may be in a corresponding one of the plurality of holes 110H. Each of the plurality of second scintillation patterns 180 may be between a corresponding one of the plurality of radiation sources 170 and a corresponding one of the plurality of third material patterns 140. Each of the plurality of second scintillation patterns 180 may have a uniform thickness. Each of the plurality of second scintillation patterns 180 may be at least partially surrounded by a corresponding one of the plurality of radiation sources 170.

Each of the plurality of third material patterns 140 may be between a corresponding one of the plurality of second scintillation patterns 180 and a corresponding one of the plurality of fourth material patterns 150. Each of the plurality of third material patterns 140 may be at least partially surrounded by a corresponding one of the plurality of second scintillation patterns 180.

Each of the plurality of radiation sources 170 may comprise a radioactive isotope that emits alpha rays. The plurality of first scintillation patterns 160 and the plurality of second scintillation patterns 180 may be configured to emit photons when alpha rays are applied thereto.

A depletion region between the substrate 110 and the plurality of second material patterns 120 to which photons are emitted from the plurality of first scintillation patterns 160 may generate electron-hole pairs to produce an electromotive force. A depletion region between the plurality of third material patterns 140 and the plurality of fourth material patterns 150 to which photons are emitted from the plurality of second scintillation patterns 180 may generate electron-hole pairs to produce an electromotive force.

Aspects of the present disclosure have been described above in detail with reference to the drawings. However, the configurations illustrated in the drawings and the aspects described in the present specification are only examples of the technical features of the present disclosure and do not reflect all the technical ideas of the present disclosure. Thus, it should be understood that various equivalents and modifications to the described or depicted configurations would have been made at the filing date of the present application.

1. An integrated battery comprising:
a substrate comprising a first material, the substrate including a plurality of holes;
a plurality of second material patterns each comprising a second material, wherein each second material pattern of the plurality of second material patterns is in a respective one of the plurality of holes, and wherein the second material has a polarity opposite to a polarity of the first material;
a plurality of radiation sources configured to apply radiation to the substrate and the plurality of second material patterns, wherein the radiation source comprises a radioactive isotope that emits beta rays;
a plurality of third material patterns each comprising a third material; and
a plurality of fourth material patterns each comprising a fourth material, wherein each third material pattern of the plurality of third material patterns is between a corresponding one of the plurality of radiation sources and a corresponding one of the plurality of fourth material patterns.

2. The integrated battery of claim 1, wherein each radiation source of the plurality of radiation sources is between a corresponding one of the plurality of second material patterns and a corresponding one of the plurality of third material patterns.

3. The integrated battery of claim 1, wherein a conductivity type of the first material is the same as a conductivity type of the third material, and
wherein a conductivity type of the second material is the same as a conductivity type of the fourth material.

4. The integrated battery of claim 1, wherein a conductivity type of the second material is the same as a conductivity type of the third material, and
wherein a conductivity type of the first material is the same as a conductivity type of the fourth material.

5. The integrated battery of claim 1, wherein a lower surface of each of the plurality of second material patterns, a lower surface of each of the plurality of radiation sources, a lower surface of each of the plurality of third material patterns, and a lower surface of each of the plurality of fourth material patterns are coplanar with a lower surface of the substrate.

6. The integrated battery of claim 1, wherein a lower surface of each of the plurality of second material patterns, a lower surface of each of the plurality of radiation sources, and a lower surface of each of the plurality of third material patterns are coplanar with a lower surface of the substrate, and
wherein each of the plurality of third material patterns has a cup shape.

7. The integrated battery of claim 1, wherein a lower surface of each of the plurality of radiation sources and a lower surface of each of the plurality of second material patterns are coplanar with a lower surface of the substrate, and
wherein each of the plurality of radiation sources has a cup shape.

8. The integrated battery of claim 1, wherein a lower surface of each of the plurality of second material patterns is coplanar with a lower surface of the substrate, and wherein each of the plurality of second material patterns has a cup shape.

9. An integrated battery comprising:
a substrate comprising a first material, the substrate including a plurality of holes;
a plurality of second material patterns each comprising a second material, wherein each second material pattern of the plurality of second material patterns is in a respective one of the plurality of holes, and wherein the second material has a polarity opposite to a polarity of the first material;
a plurality of radiation sources, wherein each radiation source of the plurality of radiation sources is in a respective one of the plurality of holes;
a plurality of third material patterns each comprising a third material, wherein each third material pattern of the plurality of third material patterns is in a respective one of the plurality of holes, and wherein the third material pattern is spaced apart from the second material pattern in each respective one of the plurality of holes; and
a plurality of fourth material patterns each comprising a fourth material, wherein each fourth material pattern of the plurality of fourth material patterns is in a respective one of the plurality of holes.

10. The integrated battery of claim 9, wherein each radiation source of the plurality of radiation sources is between a corresponding one of the plurality of second material patterns and a corresponding one of the third material patterns.

11. The integrated battery of claim 9, wherein each third material pattern of the plurality of third material patterns is between by a corresponding one of the plurality of radiation sources and a corresponding one of the plurality of fourth material patterns.

12. The integrated battery of claim 9, wherein each fourth material pattern of the plurality of fourth material patterns is at least partially surrounded by a corresponding one of the plurality of third material patterns.

13. An integrated battery comprising:
a substrate comprising a first material, the substrate including a plurality of recesses extending into the substrate in a first direction from a first surface of the substrate;
a second material layer on the substrate, the second material layer comprising a second material;
a radiation source on the second material layer;
a third material layer on the radiation source, the third material layer comprising a third material; and
a fourth material layer on the third material layer, the fourth material layer comprising a fourth material.

14. The integrated battery of claim 13, wherein the second material has a conductivity type opposite a conductivity type of the first material, and
wherein the third material has a conductivity type opposite a conductivity type of the fourth material.

15. The integrated battery of claim 13, wherein a conductivity type of the third material is the same as a conductivity type of the first material, and
wherein a conductivity type of the fourth material is the same as a conductivity type of the second material.

16. The integrated battery of claim 13, wherein a conductivity type of the third material is the same as a conductivity type of the second material, and
wherein a conductivity type of the fourth material is the same as a conductivity type of the first material.

17. The integrated battery of claim 13, wherein the substrate includes an electrical region comprising the plurality of recesses and a contact region free from the plurality of recesses, and
wherein the substrate, the second material layer, the radiation source, the third material layer, and the fourth material layer form a step structure in the contact region.

18. The integrated battery of claim 17, wherein, in the contact region, the substrate protrudes from the electrical region into the contact region a greater distance than the second material layer.

19. The integrated battery of claim 17, wherein, in the contact region, the second material layer protrudes from the electrical region into the contact region a greater distance than the third material layer.

20. The integrated battery of claim 17, wherein, in the contact region, the third material layer protrudes from the electrical region into the contact region a greater distance than the fourth material layer.

21. The integrated battery of claim 13, wherein a first cell including the substrate and the second material layer is connected in series to a second cell including the third material layer and the fourth material layer.

22. The integrated battery of claim 13, wherein a first cell including the substrate and the second material layer is connected in parallel to a second cell including the third material layer and the fourth material layer.

23. The integrated battery of claim 13, further comprising:
a first via electrically connected to the substrate;
a second via electrically connected the second material layer;
a third via electrically connected to the third material layer; and
a fourth via electrically connected to the fourth material layer.

24. The integrated battery of claim 23, wherein the first via, the second via, the third via, and the fourth via, each include a passivation layer and a conductive layer at least partially surrounded by the passivation layer.

25. The integrated battery of claim 24, wherein the first via penetrates the second material layer, the third material layer, and the fourth material layer.

26. The integrated battery of claim 24, wherein the second via penetrates the third material layer and the fourth material layer.

27. The integrated battery of claim 24, wherein the third via penetrates the fourth material layer.

28. The integrated battery of claim 23, wherein the substrate includes an electrical region comprising the plurality of recesses, a first contact region, and a second contact region, wherein the first contact region is spaced apart from the second contact region, with the electrical region between the first contact region and the second contact region,
wherein the first via and the third via are on the first contact region, and
wherein the second via and the fourth via are on the second contact region.

29. The integrated battery of claim 28, further comprising a conductive line connected to the second via and the fourth via.

30. The integrated battery of claim 23, wherein the substrate includes an electrical region comprising the plurality of recesses, a first contact region, and a second contact region, wherein the first contact region is spaced apart from the second contact region, with the electrical region between the first contact region and the second contact region,
wherein the second via and the third via are on the first contact region, and
wherein the first via and the fourth via are on the second contact region.

31. The integrated battery of claim 23, further comprising:
a first conductive line connected to the second via and the third via; and
a second conductive line connected to the first via and the fourth via.
